(19) United States
(12) Patent Application Publication
(10) Pub. No.: US 2026/0093690 A1
(43) Pub. Date: Apr. 2, 2026

(54) SYSTEM AND METHOD FOR SYNCHRONIZING ADJUSTMENT OF INFORMATION HANDLING SYSTEM HARDWARE AND EXECUTION OF AI PRODUCTIVITY TOOL ENABLABLE SOTWARE APPLICATION CAPABILITIES

(71) Applicant: Dell Products LP, Round Rock, TX (US)

(72) Inventors: Srikanth Kondapi, Austin, TX (US); Balasingh Ponraj Samuel, Round Rock, TX (US); Daniel L. Hamlin, Round Rock, TX (US)

(73) Assignee: Dell Products LP, Round Rock, TX (US)

(21) Appl. No.: 18/904,725

(22) Filed: Oct. 2, 2024

(51) Int. Cl. G06F 16/242; G06F 21/57

(52) U.S. Cl. CPC G06F 16/243; G06F 21/575; G06F 2221/034

(57) ABSTRACT

An information handling system executing computer readable code instructions for a firmware-level artificial intelligence (AI) productivity tool may comprise a hardware processor executing code instructions for a firmware adjustment listening module to identify and report a recent execution by an AI productivity tool enableable software application, in response to a received user query input, of a responsive application capability to an embedded controller executing computer-readable code instructions for a tandem, firmware-level AI productivity tool to identify a best match hardware or firmware capability with the received user query input and identified responsive application capability generating a highest lexical similarity search score, and instructing firmware for one of the hardware components associated with the best match hardware or firmware capability to execute the best match hardware or firmware capability at a platform level of the information handling system in response to the user query input to augment the responsive application capability.

### FIELD OF THE DISCLOSURE

The present disclosure generally relates to an on the box (OTB) artificial intelligence (AI) productivity tool executing at the operating system level that employs machine learning models stored at an information handling system for optimizing user productivity and information handling system performance in response to a received user query input. The present disclosure more specifically relates to a hardware processor executing machine readable code instructions of the OTB AI productivity tool to synchronize execution of responsive AI productivity tool enableable software application capability at an operating system level with a hardware or firmware capability adjusting hardware functionality of a parallel firmware-level AI productivity tool operating at an information handling system platform level.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more artificial intelligence (AI) productivity tool enableable software applications, chat bots, or the like. Further, the information handling system may include an on the box (OTB) artificial intelligence (AI) productivity tool employing machine learning models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions for an operating system-level on the box (OTB) and firmware-level artificial intelligence (AI) productivity tools and synchronized with a firmware-level AI productivity tool for optimizing user experience and performance of hardware components at the information handling system according to an embodiment of the present disclosure;

FIG. 2 is a block diagram illustrating a hardware processor executing machine readable code instructions for an on the box (OTB) AI productivity tool to orchestrate a hardware component settings adjustment via execution of machine readable code instructions for a firmware adjustment listening module in response to a detected execution of an AI productivity tool enableable software application capability for a received user query input relative to a previous hardware component settings adjustment according to an embodiment of the present disclosure;

FIG. 3 is a block diagram illustrating a hardware processor executing machine readable code instructions for a firmware-level AI productivity tool for correlating natural language of a user’s query input to a registered natural language description of a hardware or firmware capability for hardware component to augment execution of an AI productivity tool enableable software application capability for a received user query input according to an embodiment of the present disclosure; and

FIG. 4 is a flowchart showing a method of executing machine readable code instructions of a firmware-level AI productivity tool identifying a hardware or firmware capability of a hardware component that augments execution of an AI productivity tool enableable software application capability that best matches a received user query input according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase efficiency of computing systems and interactions with humans. An example of AI technologies includes, but is not limited to, chat-enabled environments (voice, text, etc.). These chat-enabled environments are described in embodiments herein as an on the box (OTB) AI productivity tool that receives this voice or text input from a user and implements a number of actions or utilizes services of various software applications based on the natural language of the input. In some information handling systems, the OTB AI productivity tool may interface with various AI productivity tool-enablable software applications being executed or executable on the information handling system. These AI productivity tool-enablable software applications may integrate with the OTB AI productivity tool to allow user queries to trigger certain responsive capability actions declared, supported, and managed by these AI productivity tool-enablable software applications. In embodiments herein, the OTB AI productivity tool executes at the operating system level and may work in tandem with an agent, referred to herein as a firmware-level AI productivity tool, to allow the same user queries or detected changes generated by the execution of responsive capability actions of these AI productivity tool-enablable software applications to trigger certain firmware or hardware capability actions at in information handling system platform level declared and supported by firmware for various hardware components of the information handling system.

In some cases, a hardware processor executing machine readable code instructions of certain responsive capabilities for AI productivity tool-enableable software applications to a user query input may be complimented or augmented by adjustments to hardware or firmware. The OTB AI productivity tool in embodiments herein, in tandem with execution of machine readable code instructions for a firmware adjustment listening module, may listen for execution of such responsive capabilities at the operating system (OS) level and trigger execution of adjustments to firmware or hardware at the platform level for the information handling system that may complement those executions of software capabilities at the OS level. Such a complimentary hardware or firmware capability may be identified at the platform level from a condensed list of hardware and firmware capabilities stored in a library at an embedded controller executing machine readable code instructions of a firmware level AI productivity tool operating in the platform level of the information handling system.

A hardware processor executing code instructions of the OTB AI productivity tool in embodiments herein may receive user queries via an input/output device such as a keyboard, microphone, or video camera, described herein as user query inputs. The OTB AI productivity tool may match received user query inputs to known capabilities of one or more of the AI productivity tool-enableable software applications through execution by a hardware processor of machine readable code instructions for one or more natural language processing machine learning models.

The process includes gathering, either in real-time or prior to execution of the OTB AI productivity tool such as via a user, information technology decision maker, or manufacturer, application capabilities associated with each of a plurality of AI productivity tool-enablable software applications and, in some embodiments, hardware or firmware capabilities associated with each of a plurality of hardware components for the information handling system for access by the OTB AI productivity tool executing at the OS level. These capabilities (also called capability intents and having capability intent values) may describe those functionalities of each of the AI productivity tool-enablable software applications or hardware components that may be used when interfacing with the OTB AI productivity tool. These natural language descriptions of the application capabilities for the AI productivity tool-enableable software applications and a selection of hardware or firmware capabilities (e.g., for hardware driver software) for the hardware components may be stored within a natural language application capability database for comparison to received user query inputs, for example, in order to identify a capability most likely to address a user’s request within the received user query inputs. As described below, some hardware or firmware capabilities, including firmware drivers, for the hardware components may not be accessible as part of the OTB AI productivity tool executing at the OS level and may instead be firmware managed and executed at the information handling system platform level. Instead of burdening the hardware processor executing the OTB AI productivity tool, such hardware or firmware capabilities, including firmware drivers, for the hardware components may be identified and executed via execution of parallel machine readable code instructions of a firmware level AI productivity tool in embodiments herein.

A hardware processor executing machine readable code instructions for a capability intent value generator embedding process of the OTB AI productivity tool may determine capability intent values associated with these natural language descriptions of the gathered capabilities for each of a plurality of AI productivity tool-enablable software applications at the operating system level. These capability intent values are a mathematical representation, such as a vectorized capability intent value in a multi-axis vector space, of capability operations or services from various AI productivity tool-enablable software applications or hardware components in embodiments herein. These capability intent values may be represented by a mathematical value in a multi-axis vector space that may be associated with a natural language description for that capability or intent where plural axes represent values related to meaning of natural language words or phrases. In an embodiment, the application capabilities and hardware or firmware capabilities may be associated with an identification (ID) such as an alphanumeric ID that also may be stored within a capability intent values database. Generating such capability intent values as vectors may be a first step in a natural language processing method of execution of a large language model (LLM) for an OTB AI productivity tool to determine and correlate the user’s query intent or requested action within a user query input that takes into account the context or semantics of the words used within the user query input with one of a plurality of capabilities of AI productivity tool enableable software applications.

Upon receipt of a user query input by the OTB AI productivity tool in embodiments herein, a hardware processor executing code instructions of a query intent determination module may determine a vectorized query input intent value for the user query input that may be comparable to the capability intent values. The hardware processor executing machine readable code instructions for a query intent to capability determination module in embodiments herein may then perform one or more similarity search methods to match the query input intent value with a capability intent value in order to identify an application capability for an AI productivity tool-enableable software application or, in some embodiments, a selection of hardware or firmware capabilities for hardware components at the OS level that most closely corresponds and can address the user request within the user query input.

A methodology for matching text or documents in embodiments herein may center upon lexical matching or keyword searches, such as term frequency-inverse document frequency (TF-IDF) searches. TF-IDF searches in this context focus upon the frequency of a term or keyword found within a user query input and within known capabilities for the AI productivity tool enableable software applications. TF-IDF methodologies lack the ability to determine context of the various keywords identified within the user query input, however. For example, TF-IDF methodologies cannot discern between different meanings for the same word or identify synonyms for keywords, which people routinely employ in natural language conversation. This may result in limits for matching between natural language text excerpts, such as the user query input and the software service or function described in a natural language application capability for an AI productivity tool-enableable software application or a function described in a natural language hardware or firmware capability for a hardware component.

In embodiments herein, a hardware processor may execute machine readable code instructions for a semantic similarity search machine learning model that analyzes and weighs context and relevancy to overcome this disadvantage of TF-IDF methodologies. For example, in embodiments herein, a hardware processor may execute machine readable code instructions for a semantic similarity search machine learning model, via a query intent to capability determination module, that compares the vectorized user query input intent value and the capability intent values stored within the capability intent values database associated determined from the natural language application capability database at the OS level with the AI productivity tool. Such a comparison may be performed using a semantic search machine learning model, such as a cosine similarity search that compares the distance or value difference in a multi-axis vector space between two vectors (e.g., the capability intent value vector and the user query input value vector) to determine the contextual similarity between the natural language description of the application capability or hardware or firmware capability and the natural language user query input. Such a contextual or semantic search methodology may take into account the fact that the same word may have two meanings or consider synonyms of words, for example. This may be performed for several of the capability intent values stored within the capability intent value database to identify a capability intent value that most closely matches the user query input value. In such a way, a hardware processor executing code instructions for the query intent to capability determination module for the OTB AI productivity tool may take relevance and context of natural language within a user query input into account when determining a matching application capability of an AI productivity tool enableable software application or select matching hardware or firmware capabilities of hardware components, such as via software drivers, that is most likely to address the user’s intent within the user query input.

In some cases, execution of an application capability for an AI productivity tool enableable software application at the OS level may require or be augmented by adjustment of settings for one or more hardware components or firmware at the platform level for the information handling system and not identified or listed at the OS level in a natural language application capability database. For example, a user query input requesting that the OTB AI productivity tool make the system more secure may prompt execution of an application capability at the OS level of an AI productivity tool enableable software application to scan for viruses or to download an update for a virus protection software application. In such a case, execution of one or both of these application capabilities at the OS level may be augmented by also updating basic input/output system (BIOS) secure boot procedures and protocols for execution at the platform level of the information handling system that authenticate or validate security for hardware components of the information handling system and are not accessed via the OS level.

The hardware processor executing machine readable code instructions for a firmware adjustment listening module in embodiments herein may detect when an application capability for an AI productivity tool enableable software application is executed by the OTB AI productivity tool at the OS level in response to a user query input, and determine that the executed application capability is associated with a suggestion or requirement to augment that execution with execution of a hardware or firmware capability or firmware at the platform level in an embodiment. Such a determination may be made in embodiments herein through access to a lookup table by an embedded controller or other hardware processing resource directly associating the responsive application capability executed at the OS level with a recommendation to augment that execution with execution of a hardware or firmware capability at the platform level, or through analysis via a neural network based on past usage data for the information handling system or for the OTB AI productivity tool, for example.

Upon determination that the responsive application capability executed at the OS level is occurring and is identified the hardware processor executing machine readable code instructions of the firmware adjustment listening module may forward the received user query input that prompted the responsive application capability for the AI productivity tool enableable software application execution at the OS level or identification of the responsive application capability to a firmware-level AI productivity tool executing via the embedded controller or other hardware processing resource operating at the platform level. The firmware-level AI productivity tool executing via the embedded controller may determine that the received user query input, the identified responsive application capability, or both are associated with a recommendation to augment that execution. The firmware-level AI productivity tool may be operating below the OS level, independently from the OTB AI productivity tool and the OS, to determine the best hardware or firmware capability to execute at the platform level in order to augment the AI productivity tool enableable software application capability executed at the OS level in response to the received user query input.

An embedded controller executing code instructions of the firmware-level AI productivity tool in embodiments herein may match such a received user query input to known hardware or firmware capabilities of one or more hardware components through execution by the embedded controller of machine readable code instructions for one or more natural language processing machine learning models. This process includes gathering, either in real-time or prior to execution of either the OTB AI productivity tool or the firmware-level AI productivity tool, hardware or firmware capabilities for a plurality of hardware components accessible at the information handling system platform level via control of the embedded controller or other hardware processing resources. These hardware or firmware capabilities may describe those functionalities of each of the hardware components that may be used when interfacing with the firmware-level AI productivity tool.

The natural language descriptions of the hardware or firmware capabilities for the hardware components may be stored within a natural language hardware or firmware capability library within memory accessible to the embedded controller for a lexical or keyword comparison, via the embedded controller, to received user query inputs or to identified responsive application capabilities determined at the OS level, for example, in order to identify a hardware or firmware capability most likely to address a user’s request within the received user query inputs or augmenting those identified responsive application capabilities. The stored natural language descriptions of hardware or firmware capabilities may be condensed in comparison to the much larger database of natural language descriptions of application capabilities and hardware or firmware capabilities stored in the main memory and executable at the operating system level via the OTB AI productivity tool. The firmware-level AI productivity tool executing at the platform level may perform a less complex and less processor-intensive lexical or keyword comparison of the user query input, an identified responsive application capability, or both with each of the stored natural language descriptions of the hardware or firmware capabilities to identify a hardware or firmware capability executable within firmware for a specific hardware component to perform a requested action within the user query input or the identified responsive application capability. Thus, the OTB AI productivity tool executing in tandem with the firmware-level AI productivity tool in embodiments herein may respond to a single user query input requesting that an action be taken, such as “optimize my system,” by performing an action within an AI productivity tool-enableable software application and by performing an action within firmware for a hardware components, such as adjusting settings or functionality thereof.

Upon receipt of a user query input from the OTB AI productivity tool executing at the operating system level in embodiments herein, an embedded controller executing code instructions of a lexical similarity search module at the platform level may perform a lexical similarity search method to match the natural language of the received user query input, a identified responsive application capability, or both with a natural language description of a hardware or firmware capability stored in the natural language hardware or firmware capabilities library. This may be done in order to identify a hardware or firmware capability for hardware component of the information handling system that most closely corresponds and can address the user request within the user query input while augmenting changes made with execution of identified responsive application capabilities. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and within known hardware or firmware capabilities for the various hardware components. TF-IDF methodologies are effective and processor non-intensive, making them well-suited when a single keyword within the user query input is most important to identifying a matching hardware or firmware capability for a hardware component to address the user’s concerns. For example, a user may provide a natural language user query input such as “get me through this meeting on battery power.” In such a case, it may be useful to perform a TF-IDF comparison across the stored natural language descriptions of the hardware or firmware capabilities within the library to identify the hardware or firmware capability that best addresses the specific term “battery power,” according to embodiments herein.

The firmware-level AI productivity tool in embodiments herein may perform such a lexical search comparing the natural language of the user query input, identified responsive application capability, or some combination with each of the hardware or firmware capability natural language descriptions stored within the natural language hardware or firmware capability library to generate, for each of these stored hardware or firmware capabilities, a lexical search similarity score. A highest lexical search similarity score generated in such a manner may be identified by the firmware-level AI productivity tool as a best match hardware or firmware capability for addressing the user query input or identified responsive application capabilities. The firmware-level AI productivity tool in embodiments herein may then, independently of the operating system, instruct firmware for the hardware component associated with the best match hardware or firmware capability to perform the best match hardware or firmware capability. In such a way, the embedded controller executing code instructions of the firmware-level AI productivity tool in embodiments herein may match the received user query inputs and any identified responsive application capabilities to known hardware or firmware capabilities of one or more hardware components through execution by the embedded controller of machine readable code instructions for one or more natural language processing machine learning models to make recommended adjustments to firmware or hardware upon execution of identified responsive application capabilities.

In some embodiments, adjustments made to functionality or settings for firmware or a hardware component made at the platform level may by the tracked and reported to the operating system. Determination of a natural language description of these firmware or hardware adjustments may be fed back into the OTB AI productivity tool at the operating system to determine if further augmentation with additional AI productivity tool-enableable software application capabilities or additional adjustments to firmware or hardware component functionality or settings are warranted according to embodiments herein.

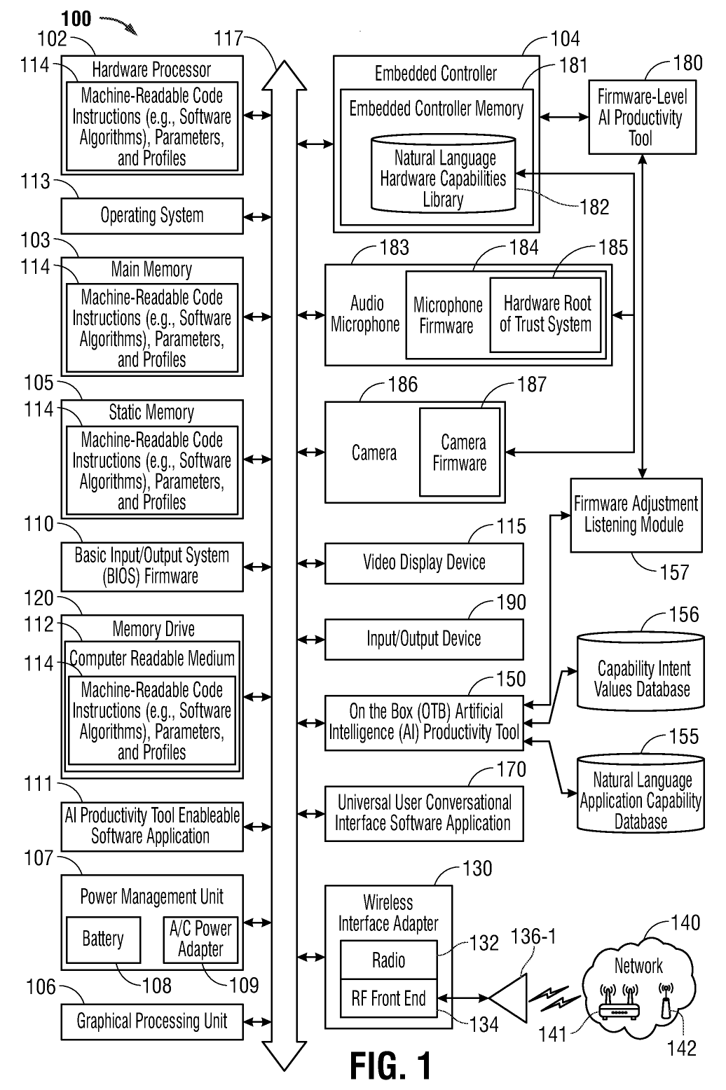

Turning now to the figures, FIG. 1 illustrates an information handling system 100 similar to the information handling systems according to several aspects of the present disclosure. As described herein, an on the box (OTB) artificial intelligence (AI) productivity tool 150 in an embodiment may implement a number of capability actions or utilize services of various AI productivity tool enableable software applications 111 based on the natural language of a received user query input, and work in tandem with a firmware-level AI productivity tool 180 to allow the same user queries or identification of responsive capability actions to trigger certain responsive hardware or firmware capability actions declared and supported by firmware (e.g., microphone firmware 184) for various hardware components (e.g., microphone 183) of the information handling system 100. In other embodiments, the user query inputs or identification of identification of responsive capability actions may trigger responsive hardware or firmware capability actions supported by other firmware for other hardware components, such as BIOS firmware 110, the camera 186, video display device 115 or the input/output device 190.

In some cases, execution of certain responsive capabilities for AI productivity tool-enableable software applications 111 may be complimented or augmented by adjustments to hardware (e.g., 108, 130, 183, 186, or 190) or firmware (e.g., 107, 110, 134, 184, 187). The OTB AI productivity tool 150 in an embodiment may further execute machine readable code instructions for a firmware adjustment listening module 157 to listen for execution of such responsive application capabilities at the operating system (OS) 113 level and trigger execution of adjustments to firmware (e.g., 107, 110, 134, 184, 187) or hardware (e.g., 108, 130, 183, 186, or 190) at the platform level for the information handling system 100 that may complement those executions of AI productivity tool enablable software 111 capabilities at the OS 113 level. Such a complimentary hardware or firmware capability may be identified at the platform level from a condensed list of hardware and firmware capabilities stored in a natural language hardware capabilities library 182 in memory accessible to an embedded controller 104 operating in the platform level of the information handling system 100 using a processor non-intensive or lightweight lexical or keyword search. In contrast, the OTB AI productivity tool 150 executing at the OS 113 level in an embodiment may determine AI productivity tool software application 111 capabilities or hardware (e.g., 108, 130, 183, 186, or 190) or firmware (e.g., 107, 110, 134, 184, 187) capabilities from a more expansive natural language capabilities database 155 using a more thorough semantic similarity search that takes into account context of the various phrases and words used in a user query input prompting execution of such AI productivity tool software application 111 capabilities or hardware (e.g., 108, 130, 183, 186, or 190) or firmware (e.g., 107, 110, 134, 184, 187) capabilities. Upon detection of any changes made to firmware (e.g., 107, 110, 134, 184, 187) or hardware (e.g., 108, 130, 183, 186, or 190) at the platform level, via the firmware adjustment listening module 157, the OTB AI productivity tool 150 may determine at the OS 113 level whether those hardware (e.g., 108, 130, 183, 186, or 190) or firmware (e.g., 107, 110, 134, 184, 187) adjustments should be complemented by additional AI productivity tool-enableable software capabilities or another hardware (e.g., 108, 130, 183, 186, or 190) or firmware (e.g., 107, 110, 134, 184, 187) adjustment using feedback into this tandem system of the AI productivity tool 150 at the operating system level 113 and the firmware-level AI productivity tool 180 at the platform level of the information handling system.

The OTB AI productivity tool 150 in an embodiment may receive, via a universal user conversational interface software application 170, a user query input requesting that an action be taken at the information handling system 100. Such a universal user conversational interface software application 170 may operate separate and apart from the AI productivity tool enableable software application 111 or in connection with the same, and may service user query requests for actions to be taken by any number of a plurality of AI productivity tool enableable software applications 111. The OTB AI productivity tool 150 may operate to identify which of the plurality of AI productivity tool enableable software applications, including 111 may be capable of performing the responsive capability action requested by the user within the user query input. Such a user query input may be made in voice format via the microphone 183, within an image captured via the camera 186, or in text format, for example, via the input/output device 190 such as a keyboard.

These processes include gathering, either in real-time or prior to execution of either the OTB AI productivity tool 150 application capabilities associated with each of a plurality of AI productivity tool-enablable software applications 111. For example, the application capabilities may be stored within the natural language software capabilities database 155. These application capabilities may describe those functionalities of each of the and each of the AI productivity tool-enablable software applications 111 and may include select software driver applications for hardware components (e.g., 108, 115, 183, 186, and 190), firmware (107, 110, 134, 184, 187), that may be used when interfacing with the OTB AI productivity tool 150. The natural language descriptions of the application capabilities for the AI productivity tool-enableable software applications 111 may be stored for semantic comparison, via the hardware processor 102 to received user query inputs, for example, in order to identify an application capability most likely to address a user’s request within the received user query inputs. In addition, the OTB AI productivity tool 150 executing at the operating system 113 level may perform a semantic comparison of the user query input and each of the stored natural language descriptions of the application capabilities to identify a responsive application capability executable within an AI productivity tool-enableable software application 111 to perform a requested action by the operating system 113 within the user query input.

However, several hardware or firmware capabilities for a plurality of hardware components (e.g., 108, 130, 183, 186, or 190) may not be included in the natural language software capabilities database 155 or accessible at the operating system level via execution of machine readable code instructions for the OTB AI productivity tool 150 or AI productivity tool-enableable software applications 111. Instead, some hardware or firmware capabilities for a plurality of hardware components (e.g., 108, 130, 183, 186, or 190) are only available via control at the information handling system platform level via an embedded controller 104 or other hardware processing resources and may not utilize or burden the hardware processor 102 executing at the operating system level or operating system 113. In such a case, an embedded controller 104 or other hardware processing resource may execute a firmware-level AI productivity tool 180 for interface with hardware or firmware capabilities for a plurality of hardware components (e.g., 108, 130, 183, 186, or 190) via user query inputs for example. The processes of operation of interfacing with hardware or firmware capabilities for a plurality of hardware components (e.g., 108, 130, 183, 186, or 190) via the firmware-level AI productivity tool 180 include gathering, either in real-time or prior to execution of the firmware-level AI productivity tool 180, hardware or firmware capabilities for the plurality of hardware components (e.g., 108, 130, 183, 186, or 190). For example, the hardware or firmware capabilities may be stored within the natural language hardware or firmware capabilities library 182 within memory 181 accessible the embedded controller 104, which may comprise flash read only memory (ROM) for example. These hardware or firmware capabilities and application capabilities may describe those functionalities of each of the hardware components (e.g., 108, 115, 183, 186, and 190), firmware (107, 110, 134, 184, 187) and may further include data linking those hardware or firmware capabilities for a plurality of hardware components (e.g., 108, 130, 183, 186, or 190) that may be used to augment or compliment the execution identified of responsive capability applications determined from AI productivity tool-enableable software applications by the OTB AI productivity tool 150 in embodiments herein.

The natural language descriptions of the hardware or firmware capabilities for the hardware components (e.g., 108, 115, 183, 186, and 190) may be stored for a lexical or keyword comparison, via the embedded controller 104 to received user query inputs, identified execution of responsive application capabilities, or some combination, in order to identify a hardware (e.g., 108, 130, 183, 186, or 190) or firmware (e.g., 107, 110, 134, 184, 187) capability most likely to address a user’s request within the received user query inputs or compliment execution of an identified responsive application capability by an AI productivity tool-enableable software application. Thus, the natural language descriptions of hardware (e.g., 108, 130, 183, 186, or 190) or firmware (e.g., 107, 110, 134, 184, 187) capabilities stored within the natural language hardware or firmware capabilities library 182 may be condensed in comparison to the much larger database 155 of natural language descriptions of application capabilities stored in the main memory 103 and executable at the operating system level with the OTB AI productivity tool 150. The firmware-level AI productivity tool 180 executing at the platform level may perform a less complex and less processor-intensive lexical or keyword comparison of the user query input, identified responsive application capability, or some combination with each of the natural language descriptions of the hardware (e.g., 108, 130, 183, 186, or 190) or firmware (e.g., 107, 110, 134, 184, 187) capabilities stored in the natural language hardware or firmware capabilities library 182 in embedded controller memory 181 to identify a hardware (e.g., 108, 130, 183, 186, or 190) or firmware (e.g., 107, 110, 134, 184) capability executable within firmware (e.g., 107, 110, 134, 184, 184) for a specific hardware component (e.g., 108, 130, 183, 186, or 190) to perform a responsive firmware or hardware capability action or perform augmented adjustments to firmware or hardware recommended or required for an identified responsive application capability to the user query input.

As described herein, a hardware processor 102 executing code instructions of the OTB AI productivity tool 150 in an embodiment may match received user queries via input/output device 190, or user query inputs, to known application capabilities of one or more of the AI productivity tool-enableable software applications 111 through execution by the hardware processor 102 of machine readable code instructions for one or more natural language processing machine learning models executing at the operating system 113 and having more robust operations than the natural language processing machine learning models executing at the platform level via the firmware-level AI productivity tool 180. For example, the hardware processor 102 executing code instructions of the OTB AI productivity tool 150 in an embodiment may match user query inputs received via the microphone 183, camera 186, or other input device 190 at the universal user conversational interface software application 170 to known application capabilities of one or more of the AI productivity tool-enableable software applications 111 executing at the operating system 113 level through execution by the hardware processor 102 of machine readable code instructions for a semantic search methodology, rather than a lexical search methodology, or in tandem with a lexical search methodology. Lexical search methodologies such as that employed by the firmware-level AI productivity tool 180 in an embodiment lack the ability to determine context of the various keywords identified within the user query input. For example, TF-IDF methodologies cannot discern between different meanings for the same word or identify synonyms for keywords, which people routinely employ in natural language conversation. This may result in limits for matching between natural language text excerpts, such as the user query input and the software service or function described in a natural language capability for an AI productivity tool-enableable software application 111 and stored within the natural language application capability database 155. In an embodiment, a hardware processor 102 may execute machine readable code instructions for a semantic similarity search machine learning model that analyzes and weighs context and relevancy to overcome this disadvantage of TF-IDF methodologies.

As a first step in such a semantic search methodology, a hardware processor 102 executing machine readable code instructions for a capability intent value generator of the OTB AI productivity tool 150 may determine capability intent values associated with the natural language descriptions of the gathered application capabilities stored within the natural language application capability database 155 for each of a plurality of AI productivity tool-enablable software applications 111 executing and available on information handling system 100. For example, an AI productivity tool-enablable software application 111 may include a word processing application such as Microsoft ® Word ® that may receive input (e.g., via voice at a microphone 183 or text via a keyboard 190) and provide output via text. Still further, other examples of an AI productivity tool-enablable software application 111 may include an updating software, virus protection software, and setting optimization software such as Dell ® SupportAssist ® module executable by the hardware processor or other hardware processing resource of the information handling system. With SupportAssist ® a user may provide input via, for example, the microphone 183 requesting information related to a setting associated with the information handling system. Thus, capabilities of SupportAssist ® may include virus protection capabilities, setting manipulation capabilities, and software updating capabilities. One or more available capabilities of AI productivity tool-enableable software applications 111 may be stored with natural language descriptions in a natural language application capability database 155 and each be embedded into a capability intent value that is stored at the associated capability intent values database 156.

Even further, examples of an AI productivity tool-enablable software application 111 may include Dell ® Display ®/Peripheral Manager ®. The Dell ® Display ®/Peripheral Manager ® may have capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these capabilities associated with the execution of the Dell ® Display ®/Peripheral Manager ® software may have capability intent values derived from natural language descriptors of each of those capabilities as gathered and stored in natural language application capability database 155 and those capability intent values with capability identifiers stored at the capability intent values database 156 as described herein. It is appreciated that the AI productivity tool-enablable software application 111 may include, for example, Dell ® Trusted Device ® software, a remediation Dell ® APEX Managed Device Service (AMDS) ® software, Alienware Command Center (AWCC) ® software, among others. Some AI productivity tool-enablable software applications 111 may even be subagents operating locally on the box of the information handling system 100 but have remote access to a larger software application executing at a cloud based server location for providing software services in some embodiments herein.

The capability intent values are a mathematical representation of application capability operations or services from various AI productivity tool-enablable software applications 111, such as from natural language descriptions of those application capabilities, in an embodiment for use in semantic search similarity comparison methodologies. These capability intent values may be represented by a mathematical value in a multi-axis vector space that may be associated with a natural language description for that application capability, as stored within the natural language application capability database 155. In an embodiment, the application capabilities stored within the natural language application capability database 155 may be associated with an identification (ID) such as an alphanumeric ID that also may be stored within a capability intent values database 156. Generating such capability intent values as vectors may be a first step in a semantic natural language processing method to determine and correlate the user’s query intent or requested action within a user query input that takes into account the context or semantics of the words used within the user query input with one of a plurality of application capabilities. The application capabilities and hardware or firmware capabilities in an embodiment may also include metadata that may indicate whether any given application capability or hardware or firmware capability, when invoked or executed, should also invoke a lexical search at the platform level for firmware or hardware capability that could augment the identified application capability or hardware or firmware capability stored in the natural language capabilities database 155. For example, an application capability to scan for viruses, which may be a best match application capability for a user query input to “make my system secure,” may be associated in metadata with an instruction to forward that user query input to the firmware-level AI productivity tool 180 for a lexical search to determine whether a corresponding firmware or hardware capability should be executed to augment execution of the virus scan.

Upon receipt of a user query input by the OTB AI productivity tool 150 in an embodiment, a hardware processor 102 executing code instructions of a query intent determination module of the OTB AI productivity tool 150 may determine a vectorized query input intent value for the user query input that may be comparable to the capability intent values. The hardware processor 102 executing machine readable code instructions for a query intent to application capability determination module of the OTB AI productivity tool 150 in an embodiment may then compare the vectorized user query input intent value and the capability intent values stored within the capability intent values database 156. Such a comparison may be performed using a semantic search machine learning model, such as a cosine similarity search that compares the distance or value difference in a multi-axis vector space between two vectors (e.g., the capability intent value vector and the user query input value vector) to determine the contextual similarity between the natural language description of the application capability and the natural language user query input. Such a contextual or semantic search methodology may take into account the fact that the same word may have two meanings or consider synonyms of words, for example.

This may be performed for several of the capability intent values stored within the capability intent value database 155 to identify a capability intent value that most closely matches the user query input value. In such a way, a hardware processor 102 executing code instructions for the query intent to application capability module for the OTB AI productivity tool 150 may take relevance and context of natural language within a user query input into account when determining a matching application capability of an AI productivity tool enableable software application 111 that is most likely to address the user’s intent within the user query input. The natural language application capability for an AI productivity tool enableable software application 111 having the highest semantic similarity search score may then be identified, via execution of machine readable code instructions of the query intent to application capability determination module of the OTB AI productivity tool 150 by the hardware processor 102 as the best match application capability most likely to address the user’s intended request within the natural language user query input. The OTB AI productivity tool 150 in an embodiment may then instruct the AI productivity tool-enableable software 111 associated with the best match application capability to perform the best match application capability. In such a way, the OTB AI productivity tool 150 may implement a number of responsive capability actions or utilize services of various AI productivity tool-enableable software applications 111 based on the natural language of a received user query input. As described in embodiments herein, the OTB AI productivity tool 150 works in tandem with a firmware-level AI productivity tool 180 to allow the same user queries to trigger additional hardware or firmware capability actions declared and supported by firmware (e.g., 107, 110, 134, 184, 187) for various hardware components (e.g., 108, 115, 183, 186, or 190) of the information handling system 100, but not accessible or controlled at the operating system level 113 or via the OTB AI productivity tool 150.

In some embodiments, execution of an application capability for an AI productivity tool enableable software application 111 at the OS level 113 may require or be augmented by adjustment of settings for one or more hardware components (e.g., 108, 115, 183, 186, or 190) or firmware (e.g., 107, 110, 184, 187) at the platform level for the information handling system 100. For example, a user query input requesting that the OTB AI productivity tool 150 make the system more secure may prompt execution of an application capability at the OS 113 level of an AI productivity tool enableable software application 111 to scan for viruses or to download an update for a virus protection software application 111. In such a case, execution of one or both of these responsive application capabilities at the OS 113 level may be identified by firmware adjustment listening module 157. Execution of one or more identified responsive application capabilities at the OS 113 level of an AI productivity tool enableable software application 111 is further augmented by also updating basic input/output system (BIOS) 110 secure boot procedures and protocols for execution at the platform level of the information handling system 100 that authenticate or validate security for hardware components (e.g., 108, 115, 183, 186, or 190) of the information handling system 100.

More specifically, the embedded controller 104 may execute a firmware or hardware capability for updating BIOS 110 secure boot procedures and protocols to authenticate or validate security for hardware components (e.g., microphone 183) according to national institute of standards and technology (NIST) security recommendations, or to update a cryptographic algorithm or keys maintained within a hardware root of trust (HRoT) system (e.g., 184) of the hardware component (e.g., 183) used therein for validating the hardware component as a trusted or secure hardware component during a secure boot up of the BIOS 110. This execution of the firmware or hardware capability for updating BIOS 110 secure boot procedures and protocols may be automatically engaged via execution of code instructions of the firmware level AI productivity tool 180 by embedded controller 104 upon receiving identification of the identified responsive application capability to update virus software or scan for viruses, receiving the user query input, or some combination.

The application capabilities and hardware or firmware capabilities in an embodiment may also include metadata stored in the natural language application capabilities database 155 that may indicate whether any given application capability or selected hardware or firmware capabilities, when invoked or executed at the operating system level by an AI productivity tool 150, should also invoke a lexical search at the platform level for firmware or hardware capability that could augment the identified responsive application capability or selected hardware or firmware capability. In another embodiment, a natural language capabilities library 182 at the platform level and accessible by the embedded controller 104 may include a firmware or hardware capability intent or natural language description that indicates that a platform-level hardware or firmware capability requires or is recommended for adjustment when a given responsive application capability executed at the operating system level by an AI productivity tool 150 is identified.

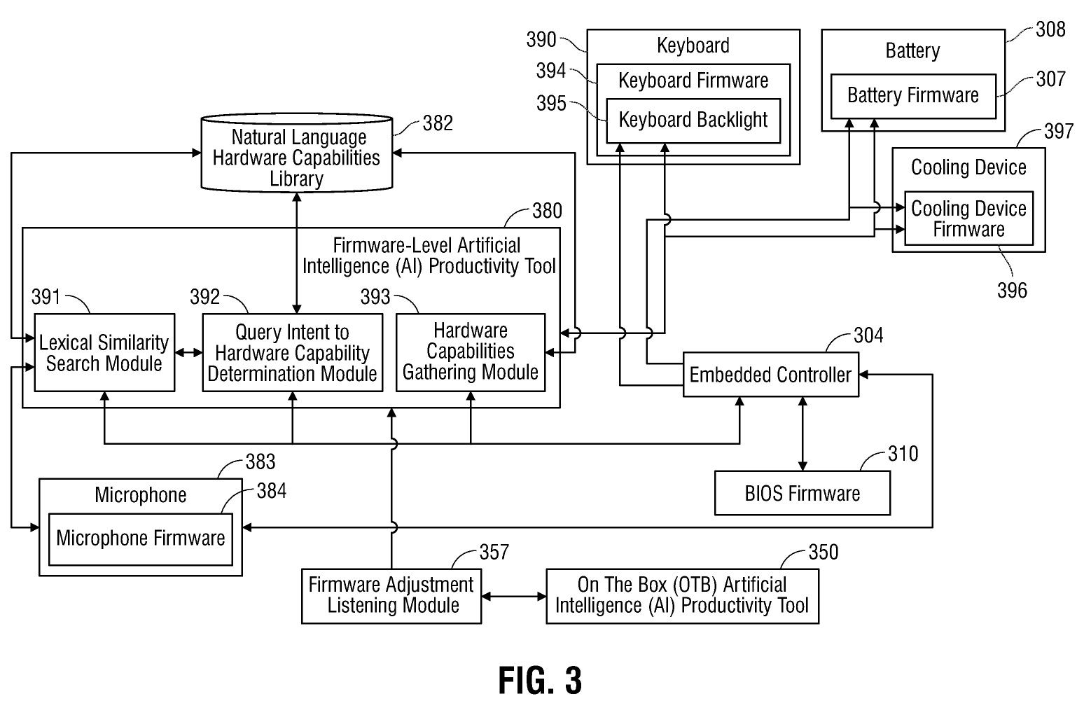

For example, a responsive application capability to scan for viruses, which may be a best match application capability for a user query input to “make my system secure,” may be associated in metadata with an instruction to forward that user query input to the firmware-level AI productivity tool 180 for a lexical search to determine whether a corresponding firmware or hardware capability should be executed to augment execution of the virus scan in one embodiment. In another embodiment, identification in metadata of a responsive application capability to scan for viruses, which may be a best match application capability for a user query input to “make my system secure,” may be sent to the firmware level AI productivity tool 180 to be lexically matched to determine whether a corresponding firmware or hardware capability should be executed via the embedded controller 104 or other hardware resource at the platform level to augment execution of the virus scan at the operating system level. More specifically, and as described in greater detail below with respect to FIG. 3 below, such a user query input to “make my system secure,” metadata identifying a virus scan or updates to virus software, or some combination may be associated via execution of the firmware level AI productivity tool 180 with a best match firmware or hardware capability via natural language hardware capabilities library 182 to perform a secure BIOS boot process update.

Such metadata identification may be established in an embodiment via an information technology decision maker (ITDM), user or other for identifying one or more executing responsive application capabilities by the firmware adjustment listening module 157. In other embodiments, determination of such metadata identifying and linking responsive application capabilities with firmware or hardware capabilities, or linking one firmware or hardware capability with another firmware or hardware capability may be made by a neural network analyzing past usage of the information handling system 100 during execution of machine readable code instructions of the firmware adjustment listening module 157. In other words, usage patterns indicating that a responsive application capability at an operating system level has routinely been performed in tandem with a firmware or hardware capability at a platform level, or that one firmware or hardware capability has been routinely performed at an operating system level in tandem with a second firmware or hardware capability at a platform level may result in metadata linking the two operating system level responsive application capability and the platform level firmware or hardware capability.

An embedded controller 104 executing code instructions of a lexical similarity search module of the firmware-level AI productivity tool 180 in an embodiment may then perform a lexical similarity search method to match the natural language text of the received user query input, the identification of the responsive application capability executing at the operating system level, or a combination of both with a natural language description of a hardware or firmware capability stored in the natural language hardware or firmware capabilities library 182 in order to identify a hardware or firmware capability for hardware component (e.g., 108, 115, 183, 186, 190) of the information handling system 100 that most closely corresponds and can address the user request within the user query input and augment the responsive application capability. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input or an responsive application capability identification as well as within known hardware or firmware capabilities for the various hardware components (e.g., 108, 115, 183, 186, 190). TF-IDF methodologies are effective and processor non-intensive, making them well-suited when a single keyword within the user query input is most important to identifying a matching hardware or firmware capability for a hardware component (e.g., 108, 115, 183, 186, 190) to address the user’s concerns. For example, a user may provide a natural language user query input such as “get me through this meeting on battery power” and execute a responsive application capability relating to limiting execution of one or more background applications with an application manager. In such a case, it may be useful to perform a TF-IDF comparison via execution of the firmware level AI productivity tool 180 by embedded controller 104 across the stored natural language descriptions of the hardware or firmware capabilities within the natural language hardware or firmware capability library 182 to identify the hardware or firmware capability that best addresses the specific term “battery power,” according to embodiments herein.

The firmware-level AI productivity tool 180 in an embodiment herein may perform such a lexical search comparing the natural language of the user query input or responsive application capability identified with each of the hardware or firmware capability natural language descriptions stored within the natural language hardware or firmware capability library 182 to generate, for each of these stored hardware or firmware capabilities, a lexical search similarity score. A highest lexical search similarity score generated in such a manner may be identified by the firmware-level AI productivity tool 180 as a best match hardware or firmware capability for addressing the user query input to augment the responsive application capability identified as being executed. The firmware-level AI productivity tool 180 in an embodiment may then, independently of the operating system 113, instruct firmware (e.g., 107, 110, 134, 184, 187) for the hardware component (e.g., 108, 115, 130, 183, 186, or 190 respectively) associated with the best match hardware or firmware capability to perform the best match hardware or firmware capability. In such a way, the embedded controller 104 executing code instructions of the firmware-level AI productivity tool 180 in an embodiment may match the received user query inputs, responsive application capability identified as executing, or some combination to known hardware or firmware capabilities of one or more hardware components (e.g., 108, 115, 130, 183, 186, 190) through execution by the embedded controller 104 of machine readable code instructions for one or more natural language processing machine learning models.

In some cases, adjustments made to functionality or settings for firmware (e.g., 107, 110, 134, 184, 187) or a hardware component (e.g., 108, 115, 130, 183, 186, or 190) may be augmented by additional adjustments to AI productivity tool-enablable software application capabilities and, in tandem with the firmware-level AI productivity tool, to firmware (e.g., 107, 110, 134, 184, 187) or hardware component (e.g., 108, 115, 130, 183, 186, or 190) functionality or settings. This may not be immediately evident without reporting of the platform level adjustments to the firmware or hardware conducted by the embedded controller to the operating system and the OTB AI productivity tool 150, such as that described directly above. Further, such additional firmware (e.g., 107, 110, 134, 184, 187) or hardware component (e.g., 108, 115, 130, 183, 186, or 190) adjustments are made by embedded controller and firmware-level AI productivity tool 180 independently of the OTB AI productivity tool 150 and the operating system 113. Thus, there is a need to perform a semantic similarity search at the operating system 113 level that is capable of considering semantic context to detect whether such a previously performed firmware (e.g., 107, 110, 134, 184, 187) or hardware component (e.g., 108, 115, 130, 183, 186, or 190) adjustment may be augmented by another software application capability or further firmware (e.g., 107, 110, 134, 184, 187) or hardware component (e.g., 108, 115, 130, 183, 186, or 190) adjustment. The hardware processor 102 executing code instructions of the firmware adjustment listening module 157 may detect that a firmware (e.g., 107, 110, 134, 184, 187) or hardware component (e.g., 108, 115, 130, 183, 186, or 190) adjustment has been made and generate a natural language description of such an adjustment. For example, the hardware processor 102 executing code instructions of the firmware adjustment listening module 157 may generate a natural language description of updating the BIOS 110 boot image. The hardware processor executing code instructions of the firmware adjustment listening module 157 may monitor the traffic and executions of the embedded controller 104 executing the firmware-level AI productivity tool 180 and determine such a natural language description of adjustments at the platform level to firmware or hardware and may be used to update a system state monitoring service for state of settings of firmware and hardware in an example embodiment.

In an embodiment, the natural language description of a firmware or hardware capability adjustment to the state of firmware or hardware of the information handling system may be reported to the system state monitoring service operating at the operating system level. The hardware processor 102 executing machine readable code instructions of the OTB AI productivity tool 150 in embodiments may use, as input, this reported natural language description of platform level adjustments to firmware and hardware by the firmware adjustment listening module 157 to perform the same semantic similarity search described above with respect to an incoming user query input on the natural language description of the firmware (e.g., 107, 110, 134, 184, 187) or hardware component (e.g., 108, 115, 130, 183, 186, or 190) adjustment to determine if further software application capabilities or even firmware (e.g., 107, 110, 134, 184, 187) or hardware component (e.g., 108, 115, 130, 183, 186, or 190) adjustments may be needed, recommended, or appropriate as feedback to the OTB AI productivity tool 150 working in tandem with the firmware-level AI productivity tool 180.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 190, a video/graphics display device 115, an audio microphone 183 for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100. In a specific embodiment, machine readable code instructions for the OTB AI productivity tool 150, a universal user conversational interface software application software application 170, a firmware-level AI productivity tool 180, a firmware adjustment listening module 157, and one or more AI productivity tool enableable software applications 111 may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 190, 183, 186, as well as between hardware processors 102, an EC 104, GPU 106 or other, the operating system (OS) 113, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 190 described herein. As described herein, the information handling system 100 further includes a video/graphics display device 115. The video/graphics display device 115 in an embodiment may function as a liquid crystal display (LCD), an organic light emitting diode (OLED), a flat panel display, or a solid-state display. It is appreciated that the video/graphics display device 115 may be wired or wireless and may be an external video/graphics display device 115 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 115, or other wired I/O devices 183, 186, or 190 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

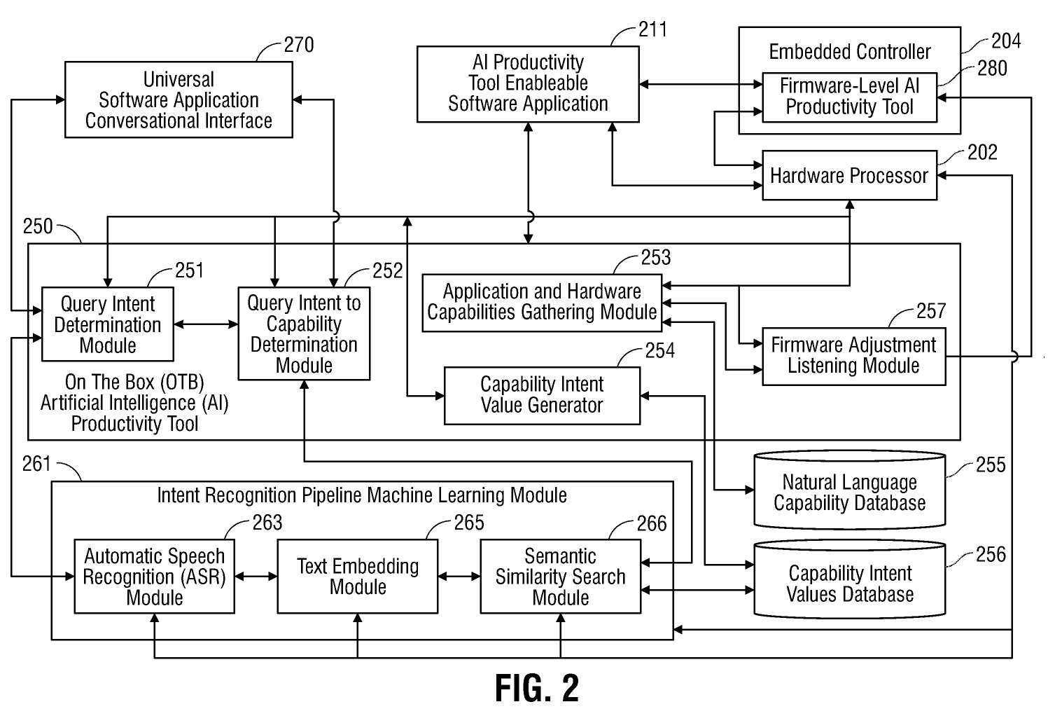

FIG. 2 is a block diagram illustrating an on the box (OTB) AI productivity tool for orchestrating a hardware component settings adjustment in response to a detected execution of an identified responsive application capability of an AI productivity tool-enableable software application to a received user query input to augment the responsive application capability according to an embodiment of the present disclosure. As described herein, a hardware processor 202 executing code instructions of the OTB AI productivity tool 250 in an embodiment may match user query inputs received via a universal user conversational interface software application 270 to known capabilities of one or more of the AI productivity tool-enableable software applications 211 through execution of machine readable code instructions for one or more natural language processing machine learning models of the OTB AI productivity tool 250.

In some embodiments, execution of certain capabilities for AI productivity tool-enableable software applications 211 may be complimented or augmented by adjustments to hardware (e.g., 107, 115, 130, 183, 186, or 190 of FIG. 1) or firmware (e.g., 110, 184, or 187 of FIG. 1) that are not able to be made at the operating system level. The OTB AI productivity tool 250 in embodiments herein, in tandem with a firmware adjustment listening module 257, may listen for execution of responsive application capabilities at the operating system (OS) level, via the OTB AI productivity tool 250, and identify the responsive application capabilities with metadata or a natural language description. The identified responsive application capabilities in metadata or by natural language are forwarded by the firmware adjustment listening module 257 to the firmware level AI productivity tool 280 to match with and trigger execution of adjustments to firmware (e.g., 110, 184, or 187 of FIG. 1) or hardware (e.g., 107, 115, 130, 183, 186, or 190 of FIG. 1) at the platform level for the information handling system that may complement those executions of the identified responsive software application capabilities at the OS level. Such a complimentary hardware or firmware capability may be identified at the platform level from a condensed list of hardware and firmware capabilities stored in a natural language hardware capabilities library (182 of FIG. 1) at an embedded controller 204 operating in the platform level of the information handling system using a processor 204 non-intensive or lightweight lexical or keyword search.

In contrast, the OTB AI productivity tool 250 executing at the OS level in embodiments here may determine AI productivity tool software application 211 capabilities or software drivers for select hardware (e.g., 108, 115, 130, 183, 186, or 190 of FIG. 1) or firmware (e.g., 110, 184, or 187 of FIG. 1) capabilities from a more expansive natural language capabilities database 255 using a more thorough semantic similarity search that takes into account context of the various phrases and words used in a user query input prompting execution of such AI productivity tool software application 211 capabilities or software drivers of select hardware (e.g., 108, 115, 130, 183, 186, or 190 of FIG. 1) or firmware (e.g., 110, 184, or 187 of FIG. 1) capabilities. Further, upon detection of any changes made to firmware (e.g., 110, 184, or 187 of FIG. 1) or hardware (e.g., 108, 115, 130, 183, 186, or 190 of FIG. 1) at the platform level, the OTB AI productivity tool 250 may determine at the OS level whether those hardware (e.g., 108, 115, 130, 183, 186, or 190 of FIG. 1) or firmware (e.g., 110, 184, or 187 of FIG. 1) adjustments should be complemented by another software application capability execution or another hardware (e.g., 108, 115, 130, 183, 186, or 190 of FIG. 1) or firmware (e.g., 110, 184, or 187 of FIG. 1) adjustment using this more thorough and processor 202 intensive semantic similarity search of the more expansive natural language capabilities database 255 in other embodiments.

The OTB AI productivity tool 250 in an embodiment may receive, via a universal user conversational interface software application 270 or other interface, a voice, image, or text input from a user, described herein as a user query input, that requests actions or services of various software applications in natural language. A hardware processor 202 executing code instructions of the OTB AI productivity tool 250 in an embodiment may match these received user query inputs to known application capabilities of one or more of the AI productivity tool-enableable software applications 211 or software drivers for select known hardware or firmware capabilities of one or more hardware components (e.g., 108, 110, 115, 130, 183, 186, or 190 from FIG. 1) through execution by the hardware processor 202 of machine readable code instructions for one or more natural language processing machine learning models. AI productivity tool enableable software application 211 may have or publish a list of recognized application capabilities or functionalities that it may perform during execution of such an AI productivity tool enableable software application 211 in response to a query input received and processed by the OTB AI productivity tool 250 into a query intent vector value. Software drivers of select firmware for various hardware components (e.g., 108, 110, 115, 130, 183, 186, or 190 from FIG. 1) may also have or publish a list of recognized hardware or firmware capabilities or functionalities that it may perform. The application capabilities and software drivers of select hardware or firmware capabilities are provided text descriptors that may be processed into vectorized capability intent values in a multi-axis vector space via embedding algorithm applied to the natural language descriptions of the capabilities. These embedded vectorized capability intent values are mathematical representations of an application capability that may be correlated by a semantic similarity matching algorithm to a query intent value generated via an embedding algorithm of a user query input to select a responsive application capability that is a best match to be responsive to a user query input from a user.

This process of an execution of the OTB AI productivity tool 250 includes gathering, either in real-time or prior to execution of the OTB AI productivity tool 250, via the application and hardware or firmware capabilities gathering module 253, application capabilities associated with each of a plurality of AI productivity tool-enablable software applications 211 including software drivers for select hardware or firmware capabilities associated with each of a plurality of hardware components (e.g., 108, 110, 115, 130, 183, 186, or 190 from FIG. 1). These application capabilities and select software drivers for hardware or firmware capabilities may describe those functionalities of each of the AI productivity tool-enablable software applications 211, or functionalities of each of the select group of hardware components (e.g., 108, 110, 115, 130, 183, 186, or 190 from FIG. 1), respectively, that may be used when interfacing with the OTB AI productivity tool 250. These natural language descriptions of the application capabilities for the AI productivity tool-enableable software applications 211 may be stored within a natural language application capability database 255 for comparison to received user query inputs, for example, in order to identify a responsive software application capability most likely to address a user’s request within the received user query inputs.

The hardware processor 202 executing machine readable code instructions of the OTB AI productivity tool 250 may determine capability intent values associated with natural language descriptions of the gathered application capabilities for each of a plurality of AI productivity tool-enablable software applications 211 or natural language descriptions of the gathered hardware or firmware capabilities for each of the plurality of hardware components (e.g., 108, 110, 115, 130, 183, 186, or 190 from FIG. 1). These capability intent values are a mathematical representation of the natural language descriptions of capability operations or services from various AI productivity tool-enablable software applications 211 or of the natural language descriptions of hardware or firmware capabilities for various hardware components (e.g., 108, 110, 115, 130, 183, 186, or 190 from FIG. 1) in an embodiment. These capability intent values may be represented by a mathematical value in a multi-axis vector space that may be associated with the natural language description for that application capability or intent. In an embodiment, the application capabilities and hardware or firmware capabilities may also be associated with an identification (ID) such as an alphanumeric ID that may be stored within a capability intent values database 256. Generating such capability intent values as vectors may be a first step in a natural language processing method to determine an application capability or hardware or firmware capability corresponding to and responsive to the user’s intent or requested action within a user query input that takes into account the context or semantics of the words used within the user query input.

The execution of these responsive application capabilities, including any software drivers for hardware or firmware capabilities, in an embodiment may also be detected by execution of a firmware adjustment listening module to generate metadata that may identify the responsive application capability to indicate whether any given application capability or hardware or firmware capability, when invoked or executed, should also invoke a lexical search at the platform level for firmware or hardware capability that could augment the identified application capability, including software drivers for a hardware or firmware capability. For example, a responsive application capability to scan for viruses, which may be a best match application capability for a user query input to “make my system secure,” may be identified in metadata and forwarded along with that user query input to the firmware-level AI productivity tool 280 for a lexical search to determine whether a corresponding firmware or hardware capability should be executed to augment execution of the virus scan. More specifically, and as described in greater detail below with respect to FIG. 3, such a user query input to “make my system secure” and meta-identified responsive application capability to scan for viruses may be associated with a best match firmware or hardware capability to perform a secure BIOS boot process firmware capability by the firmware-level AI productivity tool 280 in an embodiment herein.

In an embodiment, the capability intent values database 256 may store a plurality of capability intent values of application capabilities associated with each of a plurality of AI productivity tool-enablable software applications 211 from the natural language application capability database 255 and include a name, capability ID, natural language descriptor, or a capability intent value in some embodiments. It is understood that in some embodiments, the natural language application capability database 255 and the capability intent values database 256 may be the same database whereas in other it may be a distributed database. These application capabilities stored at the capability intent values database 256 may further include any input and output capabilities provided by the AI productivity tool-enablable software applications 211 being executed by the hardware processor 202 or any other hardware processing devices, such as embedded controller 204. For example, an AI productivity tool-enablable software application 211 may include a word processing application such as Microsoft ® Word ® that may receive input and provide output via text. Still further, other examples of an AI productivity tool-enablable software application 211 may include an updating software, virus protection software, and setting optimization software such as Dell ® SupportAssist ® module executable by the hardware processor or other hardware processing resource of the information handling system. With SupportAssist ® a user may provide input via, for example, the microphone (183 of FIG. 1) requesting information related to a setting associated with the information handling system. Thus, capabilities of SupportAssist ® may include virus protection capabilities, setting manipulation capabilities, and software updating capabilities that may each be stored at the capability intent values database 256.

Even further, examples of an AI productivity tool-enablable software application 211 may include Dell ® Display ®/Peripheral Manager ®. The Dell ® Display ®/Peripheral Manager ® may have application capabilities that include certain software driver optimization adjustments of hardware components including of screen resolution, refresh rates, and gamma correction as well as webcam settings, mouse settings, keyboard settings, stylus settings, microphone settings, and trackpad settings, among other settings and connections associated with the wired or wireless input/output devices. Again, these application capabilities associated with the execution of the Dell ® Display ®/Peripheral Manager ® software may have capability intent values and an application capability identifier stored at the capability intent values database 256 as described herein. It is appreciated that the AI productivity tool-enablable software application 211 may include, for example, Dell ® Trusted Device ® software, a remediation Dell ® APEX Managed Device Service (AMDS) ® software, Alienware Command Center (AWCC) ® software, among others. Some AI productivity tool-enablable software applications 211 may even be subagents operating locally on the box of the information handling system but have remote access to a larger software application executing at a cloud based server location for providing software services in some embodiments herein.

The application capabilities and hardware or firmware capabilities may be registered with the OTB AI productivity tool 250 in an embodiment for establishing capability intent values for these capabilities such that chat user query input embedded as query intent values may be correlated with one or more capability intent values for registered application capabilities or registered hardware or firmware capabilities, as described herein. For example, in an embodiment in which the AI productivity tool enableable software application 211 optimizes performance of other software applications, such capabilities may include automatically downloading and installing updates for such AI productivity tool enableable software applications 211, or pausing execution of background applications. In yet another example, in an embodiment in which the AI productivity tool enableable software application 211 is one of several software applications routinely executing on the information handling system, and optimized by such an OTB AI productivity tool 250, such capabilities may include automatically generating and transmitting e-mails or text messages, automatically scheduling meetings, or generating chatbot or other user interface responses.

Each of the application capabilities and hardware applications stored at the capability intent values database 256 may have a description with text descriptors, may be associated with a unique ID, and may have a capability intent value in an embodiment. Upon registration of a given application capability by the AI productivity tool enableable software application 211 and upon registration of a given hardware or firmware capability by a hardware component (e.g., 108, 110, 115, 130, 183, 186, or 190 from FIG. 1) in an embodiment, a hardware processor 202 for the information handling system may execute machine readable code instructions for one or more text embedding algorithms to generate a multi-dimensional vector capability intent value for that application capability that, for example, may be based on text descriptors for that application capability that may execute at the operating system level, such as software drivers for hardware or firmware. Each of these capability intent values for association with these application capabilities may also be associated with an ID such as an alphanumeric ID that may identify, uniquely, these application capabilities and hardware or firmware capabilities in the capability intent values database 256, for example. These capability intent values may later be used to determine which of the capabilities a user intends to invoke or execute within a received user query input based on similarity with a query intent value, as described herein.

As described above, the capability intent values for natural language descriptions of application capabilities for an AI productivity tool enableable software application 211, such as software drivers for hardware or firmware capabilities for a hardware component, are a vectorized mathematical representation in a multi-axis vector space of the natural language descriptions of application capability operations or services from various AI productivity tool-enablable software applications 211in an embodiment, as generated using natural language processing (NLP) techniques via execution of machine readable code instructions by the hardware processor 202 of the query intent determination module 251 and the text embedding module 265. Each axis of the multi-axis vector space may provide a measurement of various meaning value attributes of a text excerpt of words or phrases that are known to provide context or semantic understanding of the text. For example, one or more axis values may represent a reader’s understanding of a given text excerpt may depend upon the reader’s knowledge of any given word’s meaning within the text, identified phrases within the text, or the understood order or sequence of words within the text. More specifically, one or more axis values may represent the reader’s understanding as enhanced with a larger vocabulary and assigned values for which words in that vocabulary are synonyms (closer in meaning) to a given word in that text, and which words are antonyms (further away in meaning) to that given word. As another example, one or more axis values may represent the reader’s ability to identify common phrases, such as “in other words” may provide greater insight to the semantic meaning of a text excerpt using this phrase than an understanding of each of the words “in,” “other,” and “words” used separately from one another would. As yet another example, one or more axis values may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various attributes within a given initial or updated capability intent value in embodiments herein. Hundreds of vector axes may be the basis for the intent vector value in a multi-dimensional “space.” For example, a vector for a user query input intent value or for capability intent value may provide a measurement of similarity between any given word within the user query input or AI productivity tool enablable software application 211 capabilities, respectively, a measurement of dissimilarity with known antonyms, identification of any given word as part of a phrase, or usage of any given word in a specific order that is known to be of importance. In such a way, the vectorized user query input intent value and capability intent values may mathematically represent a reader’s contextual or semantic understanding of the user query input and the natural language descriptors for the application capabilities of the AI productivity tool enableable software applications 211 and for the hardware or firmware capabilities of the hardware components (e.g., 108, 110, 115, 130, 183, 186, or 190 from FIG. 1). These vectors may then be compared to one another, via the hardware processor 202 executing machine readable code instructions of the semantic similarity search module 266 to determine statistical correlation, in order to understand how alike various phrases within the user query input and capabilities are, and how alike the usage of those words and phrases are to provide a context, such as influenced by the order of those words or phrases and their relation to one another, as well as other semantic factors represented in the multi-axis vector space.

The hardware processor 202 may also execute machine readable code instructions of a text embedding module 265 to detect which of these words are nouns, verbs, or commonly used sentence structures and generate a vectorized query input intent value for the user query input. These vectorized capability intent values and vectorized query input intent values may then be compared to one another, via the hardware processor 202 executing machine readable code instructions of the semantic similarity search module 266, in order to determine a statistical correlation that represents understanding how alike various phrases within the user query input and capabilities are, and how alike the usage of those words and phrases are to provide a context, such as influenced by the order of those words or phrases and their relation to one another. For example, the hardware processor 202 executing machine readable code instructions of the semantic similarity search module 266, and in some embodiments in tandem with algorithms of the text embedding module 265 may compare the vectorized query input intent value with the capability intent values stored within the capability intent value database 254 to identify a capability intent value correlated to the query input intent value, indicating that the user query input is requesting that the AI productivity tool enableable software application 211 execute the application capability associated with that capability intent value or is requesting that a hardware component (e.g., 108, 110, 115, 130, 183, 186, or 190 from FIG. 1) execute the hardware or firmware capability associated with that capability intent value. Such a comparison, in an embodiment, may include, for example, determining a distance or a vector value difference between the vectorized query input intent value and the vectorized capability intent value or a correlation value between the two. Examples of semantic similarity search module 266 algorithms may include, for example, a Cosine Similarity search machine learning model, a vector space model (VSM) similarity search machine learning model, or a K-Means Text Clustering similarity search machine learning model. These are only a few examples of semantic similarity search algorithms that may be employed and it is contemplated that any known or later-developed semantic similarity search algorithm may also be employed.

Upon determination of a capability intent value for each of the gathered or registered AI productivity tool enableable software application capabilities, including software drivers for hardware or firmware capabilities, the OTB AI productivity tool 250 may begin processing received user query inputs from the universal conversational interface software application 270 or other interface for identification and execution of responsive application capabilities for an AI productivity tool enableable software application or other function corresponding to one of these capability intent values. In an example embodiment, a user may provide a user query input in the form of text or voice data (e.g., via IO device 190, or microphone 183 of FIG. 1) to a universal user conversational interface software application 270, executing machine readable code instructions as a chatbot with the OTB AI productivity tool 250 to simulate a conversation between the user and the AI productivity tool enableable software application 211. When a user provides a user query input in the form of text or voice data (e.g., via IO device 190, or microphone 183 of FIG. 1) to the universal user conversational interface software application 270, the hardware processor 202 executing machine-readable code instructions of the OTB AI productivity tool 250 in an embodiment may orchestrate assessment of the user’s intended goals within the user query input (e.g., what the user wishes to achieve with this communication) with determination of a query input intent value, and identify one or more application capabilities associated with the AI productivity tool enableable software application 211 or one or more hardware or firmware capabilities associated with a hardware component (e.g., 108, 110, 115, 130, 183, 186, or 190 from FIG. 1) having a correlating capability intent value and that is capable of executing a response to this user query input intent. Further, the OTB AI productivity tool 250 may initiate performance of one or more tasks employing those application capabilities or hardware or firmware capabilities to achieve the user-intended results to the user query input.

This orchestration in an embodiment may begin with the hardware processor 202 executing machine-readable code instructions of the query intent determination module 251 to receive the user query input via microphone, image, or text input, and initiate execution of machine readable code instructions for an intent recognition pipeline machine learning module 261. In an embodiment, the hardware processor 202 executing machine-readable code instructions for the intent recognition pipeline machine learning module 261 may further orchestrate any combination of a plurality of machine learning modules (e.g., 263, 265, or 266) to process the audio, image, or text input to determine the user’s intended goal or query intent within the received text or voice data of the user query input. During operation for example, the hardware processor 202 executing machine-readable code instructions of the query intent determination module 251 may load one or more machine learning models such that, for example, the text or voice input from the user may be processed through a speech recognition model 263 and/or processed through any of a plurality of natural language models (e.g., 265 or 266) or other ML models in order to determine a text of a user’s input query or a vectorized query intent value in multi-axis space of the user’s input query. For example, an automatic speech recognition (ASR) module 263, a text embedding module 265, or a semantic similarity search module 266 that work in various combinations with one another to detect a user’s audio speech input, conversion to text or detecting text, and detecting an intent, represented by generating a query intent vector value from the text of the user query input received from the universal user conversational interface software application 270 or other interface such as one specific to an AI productivity tool enableable software application.

Further, the hardware processor 202 executing machine-readable code instructions of an intent recognition pipeline machine learning module 261 may orchestrate the interplay between each of the ASR module 263, text embedding module 265, and semantic similarity search module 266 to establish a query intent vector value in a multi-axis vector space defined with these machine learning models and correlate that query intent value with a corresponding capability intent value in an embodiment. Several text embedding algorithms may be used in various embodiments herein in order to provide a vectorized mathematical representation of semantic understanding for a user query input or for a capability described in natural language. For example, the text embedding module 265 may employ a Latent Semantic Analysis (LSA) or Latent Dirichlet allocation (LDA) which may define how close each of the observed terms in the received user query input are to various synonyms. As another example, the text embedding module 265 may employ a Word2Vec algorithm, which includes a neural network trained to understand which terms or phrases should be considered closer or further away from certain synonyms or antonyms. As yet another example, the text embedding module 265 may employ a fully recurrent neural network trained to consider the order of terms within the received user query input or the natural language descriptors of the capabilities for the AI productivity tool enableable software applications 211.

In an embodiment in which the user provides text data to the AI productivity tool enableable software application 211, such an intent recognition pipeline machine learning module 261 may truncate this process to exclude processes of the ASR module 263. The hardware processor 202 executing machine-readable code instructions of the intent recognition pipeline machine learning module 261 in an embodiment may apply the text embedding module 265 to generate a query intent value as described and then return the output query intent value of the text embedding module 265 to the query intent to capability determination module 252. The query intent to capability determination module 252 may utilize the semantic similarity search module 266 for a correlation between the query intent value received and a stored capability intent value for an application capability or a hardware or firmware capability.

For example, in embodiments herein, a hardware processor 202 may execute machine readable code instructions for a semantic similarity search module 266, via a query intent to capability determination module 252, that compares the vectorized user query input intent value and the capability intent values stored within the capability intent values database 256. Such a comparison may be performed using a semantic search machine learning model, such as a cosine or other semantic similarity search algorithm that compares the distance or value difference in a multi-axis vector space between two vectors to determine the contextual similarity between the natural language description of the embedded text algorithm generated capabilities having the capability intent values and the natural language user query input having an user query input intent value generated from an embedded text algorithm. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the capability intent values stored within the capability intent value database 256 to identify a best match application capability intent value that most closely matches the user query input value, according to embodiments herein.

A hardware processor 202 executing machine readable code instructions for a semantic similarity search module 266 may determine a distance, that is a value difference of the vector intent values within the multi-axis vector space between the query input intent value and each of a plurality of capability intent values. Then, for each of those determined distances, the hardware processor 202 executing machine readable code instructions for a semantic similarity search module 266 may determine an angular similarity having a value between zero and one for the query input intent value and each of a plurality of capability intent values. This angular similarity value in an embodiment may comprise the semantic similarity search score for a given capability intent value, where zero is a worst match and one is a best match between the given capability intent value and the query input intent value.

The hardware processor 202 in an embodiment may execute machine readable code instructions of an OTB AI productivity tool 250 query intent to capability determination module 252 to identify the AI productivity tool enableable software application 211 natural language application capability, including any software drivers for a hardware or firmware capability for a hardware component (e.g., 108, 110, 115, 130, 183, 186, or 190 from FIG. 1), having a highest semantic similarity search score as the best match application capability for the received user query input. For example, the detected intent having a query intent value in a multi-axis vector space, such as “get my through this meeting on battery power,” “speed up my application,” or “send a text message” may be associated with a known application capability or functionality of AI productivity tool enableable software application 211 at the information handling system. More specifically, the intent “get me through this meeting on battery power” may be associated with a capability for pausing execution of background applications, based on similarity correlation between a query intent value and a capability intent value as determined by the semantic similarity search module 266. As another example, the intent “make my system secure” may be associated with an application capability to scan for viruses or to download an update for a virus protection software application. In yet another example, the intent “diagnose a problem” may be associated with an application capability for running operating system diagnostics. As described above, these application capabilities may be registered and associated with a specific AI productivity tool enableable software application 211 at the capability intent value database 256 in an embodiment.

Upon identification of an application capability that addresses the determined query “intent” of the user within the received user query input, the hardware processor 202 executing machine-readable code instructions of the OTB AI productivity tool 250 may direct execution of one or more processes at the AI productivity tool enableable software application 211 associated with that application capability. For example, the hardware processor 202 executing machine-readable code instructions of the query intent to capability determination module 252 may directly instruct the AI productivity tool enableable software application 211 to undertake the identified application capability. In such a way, the OTB AI productivity tool may implement a number of actions or utilizes services of various software applications 211 based on the natural language of a received user query input and, according to embodiments herein, work in tandem with a firmware-level AI productivity tool 280 to allow the same user queries and identification of an executing responsive application capability to trigger certain actions declared and supported by firmware for various hardware components of the information handling system at the information handling system platform level.

As described herein, in some cases, execution of an application capability for an AI productivity tool enableable software application 211 may require or be augmented by adjustment of settings for firmware or one or more hardware components (e.g., 108, 110, 115, 130, 183, 186, or 190 from FIG. 1). For example, in an embodiment in which the user query input prompts execution of an application capability of an AI productivity tool enableable software application 211 to scan for viruses or to download an update for a virus protection software application, execution of one or both of these application capabilities may be augmented by also updating basic input/output system (BIOS) secure boot procedures and protocols that authenticate or validate security for hardware components of the information handling system. The hardware processor 202 executing machine readable code instructions for a firmware adjustment listening module 257 in an embodiment may detect when a responsive application capability is executed by the OTB AI productivity tool 250 in response to a user query and forward the same to the firmware-level AI productivity tool 280 at an embedded controller to determine that the executed identified application capability is associated with a recommendation to augment that execution with execution of a hardware or firmware capability at the platform level. For example, the firmware adjustment listening module 257 may transmit metadata to identify executing identified application capabilities in an embodiment which may invoke a lexical search at the embedded controller 204 executing the firmware-level AI productivity tool 280 for firmware or hardware capability that could augment the identified application capability. For example, an application capability to scan for viruses, which may be a best match application capability for a user query input to “make my system secure,” may be identified in metadata and forwarded with that user query input to the firmware-level AI productivity tool 280 for a lexical search to determine whether a corresponding firmware or hardware capability should be executed to augment execution of the virus scan. More specifically, and as described in greater detail below with respect to FIG. 3, such a user query input to “make my system secure” may be associated with a best match firmware or hardware capability to perform a secure BIOS boot process.

Executing responsive application capabilities may be identified in metadata by the firmware adjustment listening module 257 that is pre-established by an information technology decision maker (ITDM), user, or manufacturer for the OTB AI productivity tool 250. In other embodiments, determination of such metadata identifying executing responsive application capabilities for linking with firmware or hardware capabilities may be made by a neural network analyzing past usage of the information handling system of machine readable code instructions of the firmware adjustment listening module 257. In other words, usage patterns indicating that an executing responsive application capability has routinely been performed in tandem with a firmware or hardware capability, or that one firmware or hardware capability has been routinely performed in tandem with a second firmware or hardware capability, may result in metadata identifying the executing responsive application capability for linking the two capabilities.

Upon determination that the executed application capability is associated with a suggestion to augment that execution with execution of a hardware or firmware capability at the platform level at a firmware-level AI productivity tool 280 operating at the platform level and independently from the OTB AI productivity tool 250 and the operating system, a determination may be made of the best hardware or firmware capability to execute to augment the executed application capability as described in embodiments herein in connection to FIG. 3.

In some cases, adjustments made to functionality or settings for a hardware component, as described in greater detail with respect to FIG. 3 below, may be monitored by execution of the firmware adjustment listening module 357 which may monitor traffic of the embedded controller 204 in some embodiments. This reporting of adjustments made to functionality or settings for a hardware components by the firmware-level AI productivity tool 280 at the information handling system platform level may be reported to the operating system at a system state monitoring service for use in future execution of responsive application capabilities, including for software driver execution for adjustments to select hardware component functionality or settings at the operating system level. Further, such additional adjustments to software at the operating system level via execution of additional responsive application capabilities may be determined and recommended upon further execution of the OTB AI productivity tool 250 based on the platform level hardware component adjustments made and fed back as a further input in to the OTB AI productivity tool 250 in some embodiments. This may then ensure that all potentially useful operating system level software adjustments as well as any further firmware or hardware component adjustments that may be used to augment any previously performed responsive application capabilities to the initially received user query input by the OTB AI productivity tool 250 and the firmware-level AI productivity tool 280.

FIG. 3 is a block diagram illustrating firmware-level artificial intelligence (AI) productivity tool for correlating natural language of a user’s query input, an executing identified responsive application capability of an AI productivity tool-enableable software application, or some combination to a registered natural language description of a hardware or firmware capability for hardware component using a lexical similarity search according to an embodiment of the present disclosure. As described herein, in some cases, execution of a responsive application capability for an AI productivity tool enableable software application (e.g., 211 of FIG. 2) may require or be augmented by adjustment of settings for one or more hardware components (e.g., 308, 310, 383, 390, or 396). For example, in an embodiment in which the user query input prompts execution of an application capability of an AI productivity tool enableable software application to scan for viruses or to download an update for a virus protection software application, execution of one or both of these application capabilities may be augmented by also updating basic input/output system (BIOS) 310 secure boot procedures and protocols in firmware that authenticate or validate security for hardware components of the information handling system. The hardware processor (e.g., 202 of FIG. 2) executing machine readable code instructions for a firmware adjustment listening module 357 in an embodiment may detect and identify with metadata when a responsive application capability is executed by the OTB AI productivity tool 350 in response to a user query, and transmit that identification to the firmware-level AI productivity tool 380 to determine that the executed application capability is associated with a recommendation to augment that responsive application capability execution with execution of a hardware or firmware capability at the platform level. The hardware processor executing machine readable code instructions of the firmware adjustment listening module 357 at the OS level to forward the user query input as well as any metadata or other identification of the executing identified responsive application capability of an AI productivity tool-enableable software application in response to the received user query input to a firmware-level AI productivity tool 380 operating at the platform level. The determination that the executed application capability is associated with a suggestion to augment that execution of the identified responsive application capability of an AI productivity tool-enableable software application, via the firmware-level AI productivity tool 380, with execution of a hardware or firmware capability at the platform level occurs independently from the OTB AI productivity tool 350 and the operating system.

Upon receipt of the user query input and metadata or other identification of the executing identified responsive application capability of an AI productivity tool-enableable software application, the firmware-level AI productivity tool 380 may operate at the platform level, separate and apart from the operating system level to identify which of the plurality of hardware components (e.g., 308, 310, 383, 390, or 396) may be capable of performing the action requested by the user within the user query input. An embedded controller 304 executing code instructions of the firmware-level AI productivity tool 380 in an embodiment may match these received user query inputs, the metadata or other identification of the executing identified responsive application capability of an AI productivity tool-enableable software application, or some combination with known hardware or firmware capabilities of one or more firmware or hardware components controlled at the information handling system platform level. Examples of such firmware or hardware components controlled at the platform level include battery 308, microphone 383 or corresponding firmware 384, BIOS firmware 310, keyboard 390 or corresponding firmware 394, or cooling device 396 or corresponding firmware 397 may be controlled through execution by the embedded controller 304 of machine readable code instructions for one or more natural language processing machine learning models for the firmware-level AI productivity tool 380.

These processes for the firmware-level AI productivity tool 380 include gathering, via the embedded controller 304 executing machine readable code instructions of the hardware or firmware capabilities gathering module 393 of the firmware-level AI productivity tool 380, either in real-time or prior to execution of the firmware-level AI productivity tool 380, hardware or firmware capabilities for the plurality of hardware components controllable at the platform level of the information handling system. For example, the hardware or firmware capabilities may be stored within the natural language hardware or firmware capabilities library 382 within memory accessible by the embedded controller 304. These hardware or firmware capabilities may describe functionalities of each of the hardware components (e.g., 308, 310, 383, 390, or 396) that may be used when interfacing with the firmware-level AI productivity tool 380.

More specifically, the hardware or firmware capabilities stored within the natural language hardware or firmware capabilities library 382 may describe functionalities of the battery 308, such as various power mode settings including power saving mode. In another example, the hardware or firmware capabilities stored within the natural language hardware or firmware capabilities library 382 may describe functionalities of the keyboard 390 or corresponding firmware 394 to power on or off a keyboard backlight 395. In still another example, the hardware or firmware capabilities stored within the natural language hardware or firmware capabilities library 382 may describe functionalities of the cooling device firmware 397 to adjust settings for the cooling device 396 according to a user selectable thermal table (USTT), such as by increasing or decreasing fan speed. As yet another example, the hardware or firmware capabilities stored within the natural language hardware or firmware capabilities library 382 may describe functionalities of the BIOS firmware 310 to verify authenticity of a BIOS update according to national institute of standards and technology (NIST) security recommendations, or to update a cryptographic algorithm or keys used therein for validating the hardware component as a trusted or secure hardware component during a secure boot up of the BIOS 310.

The natural language descriptions of the hardware or firmware capabilities for the hardware components (e.g., 308, 310, 383, 390, or 396) may be stored for a lexical or keyword comparison, via the embedded controller 304 to received user query inputs, metadata or other identification of the executing identified responsive application capability of an AI productivity tool-enableable software application, or some combination, for example. A lexical or keyword comparison match of sufficient similarity matching level for a natural language descriptions of the hardware or firmware capabilities is used to identify a hardware or firmware capability most likely to address a user’s request within the received user query inputs and for augmenting the executing identified responsive application capability of an AI productivity tool-enableable software application. These natural language descriptions of hardware or firmware capabilities stored within the natural language hardware or firmware capabilities library 382 may be condensed in comparison to the much larger database of natural language descriptions of application capabilities stored in the main memory and executable at the operating system level via the OTB AI productivity tool 350 described in greater detail above with respect to FIG. 2. In addition, the OTB AI productivity tool 350 described with respect to FIG. 2 executing at the operating system level may perform a semantic comparison of the user query input and each of the stored natural language descriptions of the application capabilities. In contrast, the firmware-level AI productivity tool 380 executing at the platform level may perform a less complex and less processor-intensive lexical or keyword comparison of the user query input and each of the natural language descriptions of the hardware or firmware capabilities stored in the natural language hardware or firmware capabilities library 382 to identify a hardware or firmware capability executable within firmware 307, 310, 384, 394, or 397 for a specific hardware component 308, 383, 390, or 396 respectively, to perform a requested action within the user query input. Thus, the OTB AI productivity tool 350 described with reference to FIG. 2 above, executing in tandem with the firmware-level AI productivity tool 380 in an embodiment may respond to a single user query input requesting that an action be taken, such as “secure my system,” by performing an action of the execution of an identified responsive application capability of an AI productivity tool-enableable software application, such as executing a virus scan of an AI productivity tool-enableable software application (as described in greater detail above with respect to FIG. 2) and this may be augmented by performing a recommended action within firmware 307, 310, 384, 394, or 397 for a hardware component 308, 383, 390, or 396 respectively, such as adjusting settings or functionality thereof (e.g., verifying a secure BIOS update via firmware 310).

As described herein, a hardware processor (e.g., 202 of FIG. 2) executing machine readable code instructions for a firmware adjustment listening module 357 in an embodiment may detect when a responsive application capability is executed at the operating system level via the OTB AI productivity tool 350 in response to a user query and determine identification of that executed responsive application capability. The identification of the executing identified responsive application capability of an AI productivity tool-enableable software application, in metadata or otherwise, is transferred along with the user query input to the firmware-level AI productivity tool 380 for association with a recommendation to augment that executing identified responsive application capability with execution of a hardware or firmware capability at the platform level that is not otherwise controlled via the OTB AI productivity tool at the operating system level. Upon determination that the executed application capability is associated with a suggestion to augment that execution with execution of a best match hardware or firmware capability at the platform level by the firmware-level AI productivity tool 380 operating at the platform level, the firmware-level AI productivity tool 380 executes that responsive best match hardware or firmware capability independently from the OTB AI productivity tool 350 and the operating system.

An embedded controller 304 executing code instructions of a lexical similarity search module of the firmware-level AI productivity tool 380 in an embodiment may perform a lexical similarity search method to match the natural language text of the received user query input, identification of the executing identified responsive application capability at the operating system level, or some combination with a natural language description of a hardware or firmware capability stored in the natural language hardware or firmware capabilities library 382 in order to identify the best match hardware or firmware capability for hardware component (e.g., 308, 310, 383, 390, or 396) of the information handling system that most closely corresponds and can address the user request within the user query input. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and identification of the executing identified responsive application capability as well as frequency of terms within known hardware or firmware capabilities for the various hardware components (e.g., 308, 310, 383, 390, or 396). The lexical similarity search algorithm of TF-IDF methodologies are effective and processor non-intensive, making them well-suited when a single or plural keywords within the user query input or the identification of the executing identified responsive application capability is most important to identifying a matching hardware or firmware capability for a hardware component (e.g., 308, 310, 383, 390, or 396) to address the user’s concerns.

For example, the embedded controller 304 executing code instructions for the lexical similarity search module 391 may perform a TF-IDF algorithm to measure the frequency with which each of a plurality of natural language terms appear within the user query input and identification of the executing identified responsive application capability, as weighted by the frequency with which that term occurs in one of each of the natural language hardware or firmware capabilities stored within the natural language hardware or firmware capability library 382. More specifically, the hardware processor executing code instructions for a TF-IDF algorithm may determine a TF-IDF similarity score measuring the frequency with which each of a plurality of natural language terms, including names of various hardware components (e.g., 308, 310, 383, 390, or 396) or terms appearing in adjustable settings or policies for those hardware components appear in the user query input and identified responsive application capability, as weighted by the frequency with which each of those terms also occur within each of the natural language hardware or firmware capabilities stored at the natural language capabilities library 382. This comparison may be repeated for each of the hardware or firmware capabilities stored within the natural language hardware or firmware capability library 382, to produce a lexical similarity search score for each of the hardware or firmware capabilities. Each TF-IDF similarity score determined in such a way may have a value between zero and one. Thus, if there is a TF-IDF match between a term in a natural language description of a hardware or firmware capability, that hardware or firmware capability will have an increased weighting for a match over other hardware or firmware capabilities that do not contain this term in embodiments herein. Further, if there are multiple TF-IDF matches between a plurality of terms in a natural language description of a hardware or firmware capability, that hardware or firmware capability will have an increased weighting for a match over other hardware or firmware capabilities that only contain one matching term in embodiments herein. It is contemplated that any number of known or later-developed TF-IDF comparison algorithms may be used, including the best-match 25 (BM25) algorithm, the Okapi BM25 algorithm, and the BM-25 with fields (BM-25F).

As described herein, the embedded controller 304 executing code instructions for the lexical similarity search module 391 may perform the TF-IDF algorithm to measure the frequency with which each of a plurality of natural language terms appear within the user query input and the identified responsive application capability, as weighted by the frequency with which that term occurs in one of each of the natural language hardware or firmware capabilities stored within the natural language hardware or firmware capability library 382. For example, a user may provide a natural language user query input such as “secure my system” may trigger execution of the identified responsive application capability execution of an AI productivity tool-enableable software application for requiring password login upon waking from sleep or other security functions. In such a scenario, the embedded controller 304 executing code instructions for the lexical similarity search module 391 may determine that the hardware or firmware capability stored within the natural language hardware or firmware capability library 382 such as “validate secure BIOS update,” has a non-zero lexical similarity search score. In some embodiments, the embedded controller 304 may execute code instructions for the query intent to hardware or firmware capabilities determination module 392 to identify all hardware or firmware capabilities associated with a lexical similarity search score above a threshold value (e.g., 0.05. 0.1, 0.2) as best match hardware or firmware capabilities for execution at firmware (e.g., 307, 310, 384, 394, or 397) in response to the received user query input. In other embodiments, the embedded controller 304 may execute code instructions for the query intent to hardware or firmware capabilities determination module 392 to identify a single hardware or firmware capability associated with a highest lexical similarity search score in comparison to lexical similarity search scores for all other hardware or firmware capabilities stored within the natural language hardware or firmware capability library 382 as best match hardware or firmware capabilities for execution at firmware (e.g., 307, 310, 384, 394, or 397) in response to the received user query input. The firmware-level AI productivity tool 380 in an embodiment may then, independently of the operating system, instruct firmware (e.g., 307, 310, 384, 394, or 397) for the hardware component (e.g., 308, 383, 390, or 396, respectively) associated with the best match hardware or firmware capability to perform the best match hardware or firmware capability, such as for checking for BIOS security updates in firmware and updating if not current.

For example, in an embodiment in which the embedded controller 304 executing code instructions for the lexical similarity search module 391 determines that the hardware or firmware capability “place battery in power save mode” is a best match hardware or firmware capability responsive to a user query input and for augmenting the identified responsive application capability, the embedded controller 304 may instruct battery firmware 307 to place the battery in a preset power save mode to conserve power. In another example, in an embodiment in which the embedded controller 304 executing code instructions for the lexical similarity search module 391 determines that the hardware or firmware capability to power off a keyboard backlight 395 is a best match hardware or firmware capability responsive to a user query input and for augmenting the identified responsive application capability, the embedded controller 304 may instruct keyboard firmware 394 to power off the keyboard backlight 395. In yet another example, in an embodiment in which the embedded controller 304 executing code instructions for the lexical similarity search module 391 determines that the hardware or firmware capability to adjust settings for the cooling device 396 according to a user selectable thermal table (USTT), such as by increasing or decreasing fan speed, responsive to a user query input and for augmenting the identified responsive application capability, then the embedded controller 304 may instruct cooling device firmware 397 to increase or decrease fan speed of the cooling device 396. As yet another example, in an embodiment in which the embedded controller 304 executing code instructions for the lexical similarity search module 391 determines that the hardware or firmware capability to verify authenticity of a BIOS update according to national institute of standards and technology (NIST) security recommendations, or to update a cryptographic algorithm or keys used therein for validating the hardware component as a trusted or secure hardware component during a secure boot up of the BIOS 310 responsive to a user query input and for augmenting the identified responsive application capability, the embedded controller 304 may instruct BIOS firmware 310 to execute these hardware or firmware capabilities. In such a way, the embedded controller 304 executing code instructions of the firmware-level AI productivity tool 380 in an embodiment may match the responsive to a user query input and the identified responsive application capability with known hardware or firmware capabilities of one or more hardware components (e.g., 308, 310, 383, 390, or 396) through execution by the embedded controller 304 of machine readable code instructions for the firmware-level AI productivity tool 380.

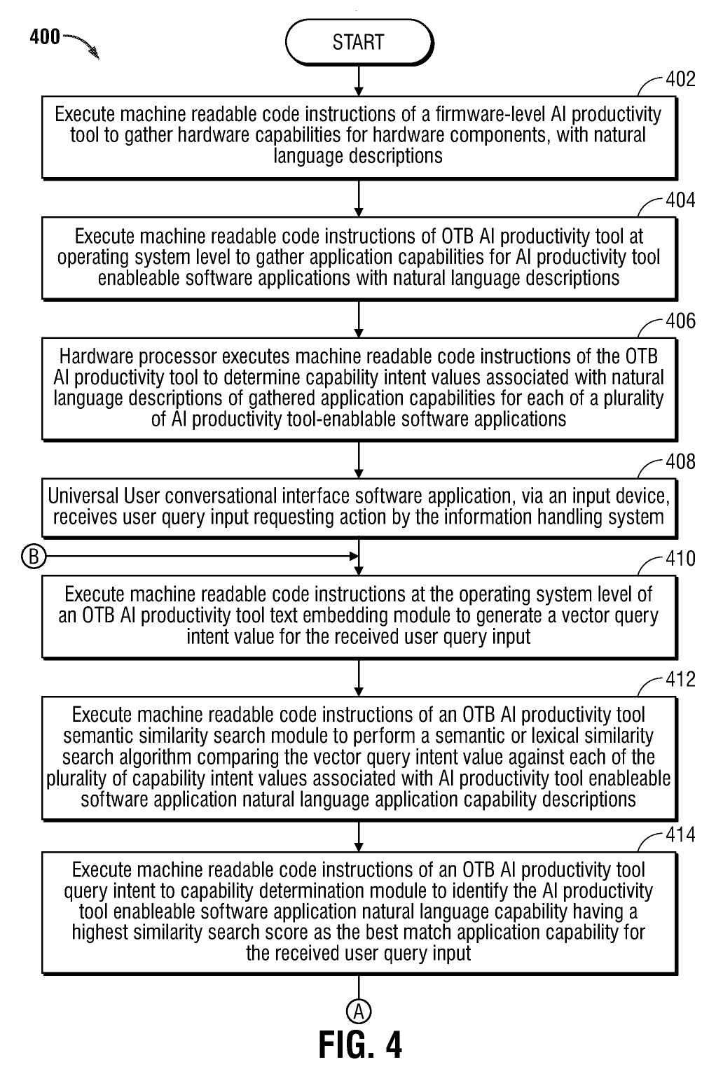

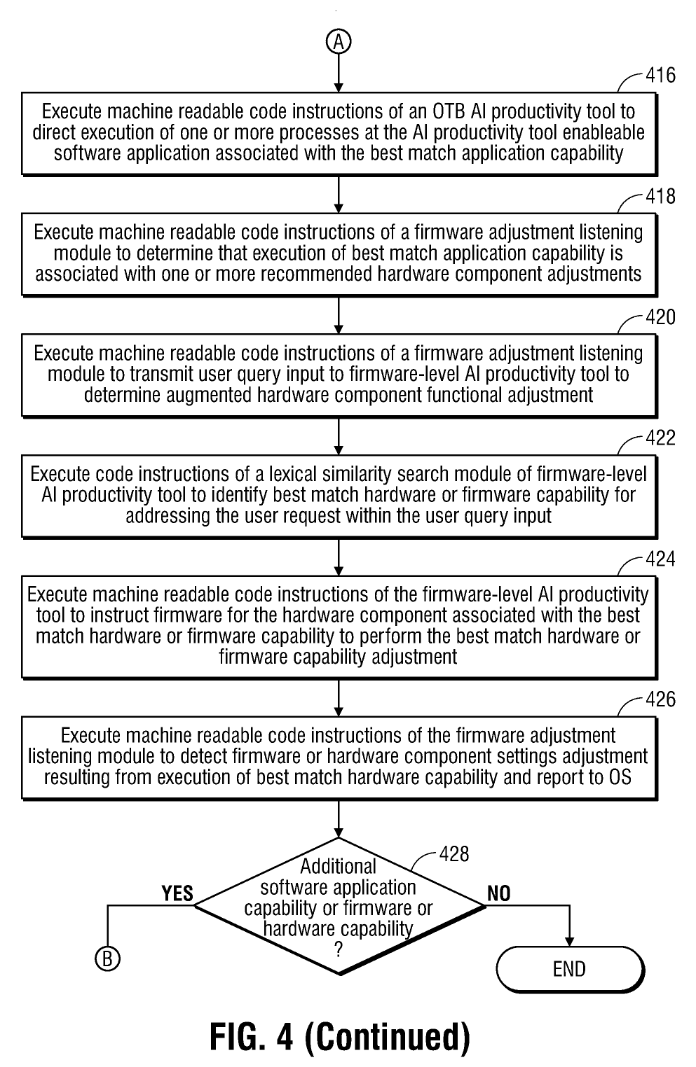

FIG. 4A is a flowchart 400 showing a method of identifying a hardware or firmware capability of a hardware component that augments execution of a responsive application capability of an AI productivity tool enableable software application that best matches a received user query input according to an embodiment of the present disclosure. It is appreciated that the method 400 described herein may be executed via execution of computer readable code instructions in firmware via an embedded controller at an information handling system platform level in parallel to execution of computer readable code instructions of software by a hardware processor or other hardware processing device at an operating system level on an information handling system. As described herein, in some cases, execution of certain capabilities for AI productivity tool-enableable software applications may be complimented or augmented by adjustments to hardware or firmware.

Execution of computer readable code instructions of the OTB AI productivity tool in embodiments herein, along with a firmware adjustment listening module, may listen for execution of such responsive application capabilities at the operating system (OS) level and trigger execution of a firmware-level AI productivity tool to identify and trigger adjustments to firmware or hardware at the platform level for the information handling system that may complement those executions of responsive application capabilities at the OS level. Such a complimentary hardware or firmware capability may be identified at the platform level by a firmware-level AI productivity tool by the embedded controller from a condensed list of hardware and firmware capabilities stored in a library using a processor non-intensive or lightweight lexical or keyword search. In contrast, the OTB AI productivity tool executing at the OS level in embodiments here may determine AI productivity tool software application capabilities or hardware or firmware capabilities from a more expansive database using a more thorough semantic similarity search that takes into account context of the various phrases and words used in a user query input prompting execution of such AI productivity tool software application capabilities or hardware or firmware capabilities. Upon detection of any changes made to firmware or hardware at the platform level, the firmware adjustment listening module may monitor activity of the embedded controller and report firmware or hardware capability adjustments to a system state monitoring service at the operating system. Then, the OTB AI productivity tool may determine at the OS level whether those hardware or firmware adjustments should be complemented by another responsive application capability action or further by additional complimentary hardware or firmware adjustments using this more thorough and processor intensive semantic similarity search of the more expansive capabilities database and determining again any platform level hardware or firmware changes in some embodiments.

The method 400 may include, at block 402, executing machine readable code instructions of a firmware-level AI productivity tool to gather hardware or firmware capabilities for hardware components controlled at the information handling system platform level, with natural language descriptions. For example, in an embodiment described with respect to FIG. 3, the embedded controller 304 may execute machine readable code instructions of the hardware or firmware capabilities gathering module 393 of the firmware-level AI productivity tool 380, either in real-time or prior to execution of the firmware-level AI productivity tool 380, to gather hardware or firmware capabilities for a plurality of hardware components (e.g., 308, 383, 390, or 396). In some embodiments, an information technology decision maker or manufacturer may determine and set the gathered hardware or firmware capabilities for hardware components controlled at the information handling system platform level with natural language descriptions More specifically, these hardware or firmware capabilities may be stored within the natural language hardware or firmware capabilities library 382 within memory 381 for the embedded controller 304. These hardware or firmware capabilities may describe functionalities of firmware (e.g., 307, 310, 384, 394, 397) or for each of the hardware components (e.g., 308, 383, 390, or 396) that may be controlled at the platform level and used when interfacing with the firmware-level AI productivity tool 380. The natural language descriptions of the hardware or firmware capabilities for the hardware components (e.g., 308, 383, 390, or 396) or for firmware (e.g., 307, 310, 384, 394, 397) may be stored for a lexical or keyword comparison, via the embedded controller 304 executing machine readable code instructions of the firmware-level AI productivity tool 380 to received user query inputs and identified responsive executing application capabilities at the operating system level, for example, in order to identify a hardware or firmware capability most likely to address a user’s request within the received user query inputs and augments the identified responsive application capabilities executing at the operating system level.

A hardware processor executing machine readable code instructions of the operating system in an embodiment at block 404 may gather software application capabilities, including software drivers for selected hardware or firmware operations, for an AI productivity tool enableable software application, with natural language descriptions. For example, in an embodiment described with respect to FIG. 2, a hardware processor 202 executing machine readable code instructions for an on the box (OTB) AI productivity tool 250 may gather, either in real-time or prior to execution of the OTB AI productivity tool 250, via the application and hardware or firmware capabilities gathering module 253, application capabilities associated with each of a plurality of AI productivity tool-enablable software applications 211. For example, an information technology decision maker, manufacturer, or user, may gather such capabilities for various AI productivity tool-enableable software applications that may execute at the operating system level on the information handling system. These application capabilities may describe those functionalities of each of the AI productivity tool-enablable software applications 211, that may be used when interfacing with the OTB AI productivity tool 250. These natural language descriptions of the application capabilities for the AI productivity tool-enableable software applications 211 may be stored within a natural language application capability database 255 for comparison to received user query inputs, for example, in order to identify an application capability most likely to respond to a user’s request within the received user query inputs.

Some gathered application capabilities, including software drivers for select hardware or firmware capabilities in an embodiment may also include metadata that may indicate whether any given application capability or hardware or firmware capability stored in the natural language capabilities database 255, when invoked or executed, should also include compensating hardware or firmware adjustments. In other embodiments, execution of code instructions of a firmware adjustment listening module may identify the responsive executing application capabilities at the operating system level and transmit this identification and any use query input to the firmware-level AI productivity tool to invoke a lexical search at the platform level for a firmware or hardware capability that could augment the identified responsive application capability. For example, a responsive application capability to scan for viruses, which may be a best match application capability for a user query input to “make my system secure” may execute at the operating system level. Metadata or a natural language description of the responsive application capability along with the user query input may be forwarded to the firmware-level AI productivity tool 280 for a lexical search to determine whether a corresponding firmware or hardware capability should be executed to augment execution of the virus scan. More specifically, and as described in greater detail with respect to FIG. 3, such a user query input to “make my system secure” may be further associated by the firmware-level AI productivity tool 280 with a best match firmware or hardware capability to perform a secure BIOS boot process at the information handling system platform level by an embedded controller or other hardware processing resource.

At block 406, a hardware processor in an embodiment may execute machine readable code instructions of the OTB AI productivity tool to determine capability intent values associated with natural language descriptions of the gathered application capabilities for each of a plurality of AI productivity tool-enablable software applications. For example, as described with FIG. 2, the hardware processor 202 executing machine readable code instructions of the OTB AI productivity tool 250 may determine capability intent values associated with natural language descriptions of the gathered application capabilities for each of a plurality of AI productivity tool-enablable software applications 211. These capability intent values are a mathematical representation of the natural language descriptions of capability operations or services from various AI productivity tool-enablable software applications 211 in an embodiment. These capability intent values may be represented by an embedded mathematical vector value in a multi-axis vector space that may be associated with the natural language description for that application capability or intent where various axis represent semantic meaning values for words or phrases and may be stored within a capability intent values database 256. In an embodiment, the application capabilities may also be associated with an identification (ID) such as an alphanumeric ID that may be stored within a capability intent values database 256. These application capabilities stored at the capability intent values database 256 may include any input and output capabilities provided by the AI productivity tool-enablable software applications 311 being executed by the hardware processor 202 or any other hardware processing devices, such as embedded controller 204. Generating such capability intent values as vectors may be a first step in a natural language processing method to determine an application capability corresponding to and responsive to the user’s intent or requested action within a user query input that takes into account the context or semantics of the words used within the user query input.

In an embodiment at block 408, the universal user conversational interface software application, via an input device, may receive a user query input at an input/output device requesting action by the information handling system. For example, in an embodiment described with respect to FIG. 3, the user may provide a user query input via an input device, such as the microphone 383, or camera 386, which may be transmitted to the universal user conversational interface software application 370. In another example embodiment, the user may provide a text user query input via a keyboard 190 of FIG. 1.

At block 410, the hardware processor operating at the operating system level in an embodiment may execute machine readable code instructions of an OTB AI productivity tool text embedding module to generate a vector query intent value via a text embedding algorithm for the received user query input. For example, in an embodiment described with respect to FIG. 2, the hardware processor 202 may execute machine-readable code instructions of the query intent determination module 251 to receive the user query input via microphone, image, or text input, and initiate execution of machine readable code instructions for an intent recognition pipeline machine learning module 261. In an embodiment, the hardware processor 202 executing machine-readable code instructions for the intent recognition pipeline machine learning module 261 may further orchestrate any combination of a plurality of machine learning modules (e.g., 263, 265, or 266) to process the audio, image, or text input to determine the user’s intended goal or query intent within the received text or voice data of the user query input.

During operation for example, the hardware processor 202 executing machine-readable code instructions of the query intent determination module 251 may load one or more machine learning models such that, for example, the text or voice input from the user may be processed through a speech recognition model 263 and/or processed through any of a plurality of natural language models (e.g., 265 or 266) or other ML models in order to determine a text of a user’s input query or an intent value of the user’s input query. For example, an automatic speech recognition (ASR) module 263, a text embedding module 265, or a semantic similarity search module 266 that work in various combinations with one another to detect a user’s audio speech input, conversion to text or detecting text, and detecting an intent, represented by generating a query intent vector value from the text of the user query input received from the universal user conversational interface software application 270 or other interface such as one specific to an AI productivity tool enableable software application. Further, the hardware processor 202 executing machine-readable code instructions of an intent recognition pipeline machine learning module 261 may orchestrate the interplay between each of the ASR module 263, text embedding module 265, and semantic similarity search module 266 to establish a query intent vector value in a multi-axis vector space defined with these machine learning models and correlate that query intent value with a corresponding capability intent value in an embodiment. The hardware processor 202 executing machine-readable code instructions of the intent recognition pipeline machine learning module 261 in an embodiment may apply the text embedding module 265 to generate a query intent value from text of the user query input as described and then return the output query intent value of the text embedding module 265 to the query intent to capability determination module 252 to a semantic similarity matching algorithm with one or more capability intent values.

At block 412, the hardware processor in an embodiment may execute machine readable code instructions of an OTB AI productivity tool semantic similarity search module to perform a semantic similarity search algorithm comparing the vector query intent value against each of the plurality of capability intent values associated with AI productivity tool enableable software application natural language application capability descriptions. For example, a hardware processor 202 may execute machine readable code instructions for a semantic similarity search module 266, via a query intent to capability determination module 252, that compares the vectorized user query input intent value and the capability intent values stored within the capability intent values database 256. Such a comparison may be performed using a semantic search machine learning model, such as a cosine or other semantic similarity search algorithm that compares the distance or value difference in a multi-axis vector space between two vectors to determine the contextual similarity between the natural language description of the embedded text algorithm generated capabilities having the capability intent values and the natural language user query input having an user query input intent value generated from an embedded text algorithm. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the capability intent values stored within the capability intent value database 256 to identify a best match application capability intent value that most closely matches the user query input value, according to embodiments herein.

A hardware processor 202 executing machine readable code instructions for a semantic similarity search module 266 may determine a distance, that is a value difference of the vector intent values within the multi-axis vector space between the query input intent value and each of a plurality of capability intent values. Then, for each of those determined distances, the hardware processor executing machine readable code instructions for a semantic similarity search module 266 may determine an angular similarity having a value between zero and one for the query input intent value and each of a plurality of capability intent values. This angular similarity value in an embodiment may comprise the semantic similarity search score for a given capability intent value, where zero is a worst match and one is a best match between the given capability intent value and the query input intent value.

The hardware processor in an embodiment at block 414 may execute machine readable code instructions of an OTB AI productivity tool query intent to capability determination module to identify the AI productivity tool enableable software application natural language application capability having a highest semantic similarity search score as the best match application capability for the received user query input. For example, the query intent to capability determination module 252 may utilize the semantic similarity search module 266 for a correlation between the query intent value received and a stored capability intent value for an application capability. More specifically, the intent “get me through this meeting on battery power” may be associated with a capability for pausing execution of background applications, based on similarity correlation between a query intent value and a capability intent value as determined by the semantic similarity search module 266. As another example, the intent “make my system secure” may be associated with an application capability to scan for viruses or to download an update for a virus protection software application. In yet another example, the intent “diagnose a problem” may be associated with an application capability for running operating system diagnostics. As described above, these application capabilities may be registered and associated with a specific AI productivity tool enableable software application 211 at the capability intent value database 256 in an embodiment. As described above, these application capabilities may be registered and associated with a specific AI productivity tool enableable software application 211 at the capability intent value database 256 in an embodiment.

In an embodiment at block 416, the hardware processor may execute machine readable code instructions of an OTB AI productivity tool to instruct the AI productivity tool enableable software application associated with the best match application capability for the received user query input to execute the best match application capability. Upon identification of a capability that addresses the determined query “intent” of the user within the received user query input, the hardware processor 202 executing machine-readable code instructions of the OTB AI productivity tool 250 may direct execution of one or more processes at the AI productivity tool enableable software application 211 associated with that application capability. For example, the hardware processor 202 executing machine-readable code instructions of the query intent to capability determination module 252 may directly instruct the AI productivity tool enableable software application 211 to undertake the identified application capability. In such a way, the OTB AI productivity tool may implement a number of actions or utilizes services of various software applications based on the natural language of a received user query input and work in tandem with a firmware-level AI productivity tool to allow the same user queries to trigger certain actions declared and supported by firmware for various hardware components of the information handling system.

At block 418 in an embodiment, the hardware processor may execute machine readable code instructions of a firmware adjustment listening module to determine and identify that execution of the best match application capability is occurring and if it is previously associated with one or more recommended hardware component adjustments. In other embodiments, the firmware adjustment listening module sends the identification of the executing responsive application capability and the user query input to a firmware-level AI productivity tool executing at a platform level to determine whether it is associated with one or more recommended firmware or hardware component adjustments. As described herein, in some cases, execution of an application capability for an AI productivity tool enableable software application may require or be augmented by adjustment of settings for firmware or one or more hardware components.

For example, in an embodiment described with respect to FIG. 2, in which the user query input prompts execution of a responsive application capability of an AI productivity tool enableable software application 211 to scan for viruses or to download an update for a virus protection software application, execution of one or both of these responsive application capabilities may be augmented by also updating basic input/output system (BIOS) secure boot procedures and protocols that authenticate or validate security for hardware components at the platform firmware level of the information handling system. The hardware processor 202 executing machine readable code instructions for a firmware adjustment listening module 257 in an embodiment may detect and identify when the responsive application capability of an AI productivity tool-enableable software application 211 is executed via the OTB AI productivity tool 250 in response to a user query input and forward that user query input and identification of the executing responsive application capability to the firmware-level AI productivity tool. The embedded controller executed machine readable code instructions of the firmware-level AI productivity tool 280 to determine that the executed application capability is to be augmented with execution of a hardware or firmware capability at the platform level. For example, the application capabilities and hardware or firmware capabilities in an embodiment may also include metadata that may indicate whether any given application capability or hardware or firmware capability, when invoked or executed, should also invoke a lexical search at the platform level for firmware or hardware capability that could augment the identified application capability or hardware or firmware capability from hardware or firmware capabilities controlled at the platform level and stored in the natural language hardware capabilities database (e.g., 382 of FIG. 3). More specifically, an application capability to scan for viruses, which may be a best match application capability for a user query input to “make my system secure,” may be associated in metadata with an instruction to forward that user query input and identification of the executing responsive application capability at the OS level to the firmware-level AI productivity tool 280 for a lexical search to determine whether a corresponding firmware or hardware capability should be executed to augment execution of the virus scan. Additionally, such a user query input to “make my system secure” and executing responsive application capability may be associated or matched with a best match firmware or hardware capability to perform a secure BIOS boot process at the platform level without involving the operating system or the OTB AI productivity tool 250.

In an embodiment at block 420, the hardware processor executing machine readable code instructions of the firmware adjustment listening module may transmit the user query input and identification of the executing responsive application capability to the firmware-level AI productivity tool to determine an augmented hardware component functional adjustment. For example, upon determination that the executed responsive application capability is executing, identification of that responsive application capability and the user query input is forwarded by the firmware adjustment listening module 257 to the firmware-level AI productivity tool 280 operating at the platform level, independently from the OTB AI productivity tool 250 and the operating system, to identify a hardware or firmware capability at the platform level that is associated with a suggestion to augment that execution with execution of the responsive application capability. The embedded controller executes machine readable code instructions of the firmware-level AI productivity tool 280 to correlate the received user query input and the identified executing responsive application capability at the operating system level with the best match hardware or firmware capability to execute to augment the executed application capability.

At block 422 in an embodiment, an embedded controller may execute code instructions of a lexical similarity search module of the firmware-level AI productivity tool to match natural language text of received user query input and identification of the responsive application capability executing at the operating system level with a natural language description of hardware or firmware capability for hardware component that most closely corresponds and can address the user request within the user query input. For example, in an embodiment described with respect to FIG. 3, an embedded controller 304 executing code instructions of a lexical similarity search module of the firmware-level AI productivity tool 380 in an embodiment may perform a lexical similarity search method to match the natural language text of the received user query input with a natural language description of a hardware or firmware capability stored in the natural language hardware or firmware capabilities library 382 in order to identify a hardware or firmware capability for firmware (e.g., 307, 310, 384, 394, or 397) or a hardware component (e.g., 308, 383, 390, or 396) of the information handling system that most closely corresponds and can address the user request within the user query input. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and within known hardware or firmware capabilities for the various hardware components (e.g., 308, 383, 390, or 396). TF-IDF methodologies are effective and processor non-intensive, making them well-suited when a single or plural keywords within the user query input are important to identifying a matching hardware or firmware capability for a hardware component (e.g., 308, 383, 390, or 396) to address the user’s concerns.

For example, the embedded controller 304 executing code instructions for the lexical similarity search module 391 may perform a TF-IDF algorithm to measure the frequency with which each of a plurality of natural language terms appear within the user query input, as weighted by the frequency with which that term occurs in one of each of the natural language hardware or firmware capabilities stored within the natural language hardware or firmware capability library 382. More specifically, the hardware processor executing code instructions for a TF-IDF algorithm may determine a TF-IDF similarity score measuring the frequency with which each of a plurality of natural language terms, including names of various hardware components (e.g., 308, 383, 390, or 396) or terms appearing in adjustable settings or policies for those hardware components appear in the user query input and identified responsive application capability, as weighted by the frequency with which each of those terms also occur within each of the natural language hardware or firmware capabilities stored at the natural language capabilities library 382. This comparison may be repeated for each of the hardware or firmware capabilities stored within the natural language hardware or firmware capability library 382, to produce a lexical similarity search score for each of the hardware or firmware capabilities. Each TF-IDF similarity score determined in such a way may have a value between zero and one. Thus, if there is a TF-IDF match between a term in a natural language description of a hardware or firmware capability, that hardware or firmware capability will have an increased weighting for a match over other hardware or firmware capabilities that do not contain this term in embodiments herein. Further, if there are multiple TF-IDF matches between a plurality of terms in a natural language description of a hardware or firmware capability, that hardware or firmware capability will have an increased weighting for a match over other hardware or firmware capabilities that only contain one matching term in embodiments herein.

In some embodiments, the embedded controller 304 may execute code instructions for the query intent to hardware or firmware capabilities determination module 392 to identify all hardware or firmware capabilities associated with a lexical similarity search score above a threshold value (e.g., 0.05. 0.1, 0.2) as best match hardware or firmware capabilities for execution at firmware (e.g., 307, 310, 384, 394, or 397) in response to the received user query input. In other embodiments, the embedded controller 304 may execute code instructions for the query intent to hardware or firmware capabilities determination module 392 to identify a single hardware or firmware capability associated with a highest lexical similarity search score in comparison to lexical similarity search scores for all other hardware or firmware capabilities stored within the natural language hardware or firmware capability library 382 as best match hardware or firmware capabilities for execution at firmware (e.g., 307, 310, 384, 394, or 397) in response to the received user query input.

The embedded controller executing machine readable code instructions of the firmware-level AI productivity tool in an embodiment at block 424 may then, independently of the operating system, instruct firmware for the hardware component associated with the best match hardware or firmware capability to perform the best match hardware or firmware capability. For example, the embedded controller 304 executing machine readable code instructions of the firmware-level AI productivity tool 380 in an embodiment may then, independently of the operating system, instruct firmware (e.g., 307, 310, 384, 394, or 397) for the hardware component (e.g., 308, 383, 390, or 396) associated with the best match hardware or firmware capability to perform the best match hardware or firmware capability. For example, in an embodiment in which the embedded controller 304 executing code instructions for the lexical similarity search module 391 determines that the hardware or firmware capability “place battery in power save mode” is a best match hardware or firmware capability, the embedded controller 304 may instruct battery firmware 307 to place the battery in a preset power save mode to conserve power. In another example, in an embodiment in which the embedded controller 304 executing code instructions for the lexical similarity search module 391 determines that the hardware or firmware capability to power off a keyboard backlight 395 is a best match hardware or firmware capability, the embedded controller 304 may instruct keyboard firmware 394 to power off the keyboard backlight 395. In yet another example, in an embodiment in which the embedded controller 304 executing code instructions for the lexical similarity search module 391 determines that the hardware or firmware capability to adjust settings for the cooling device 396 according to a user selectable thermal table (USTT), such as by increasing or decreasing fan speed, the embedded controller 304 may instruct cooling device firmware 397 to increase or decrease fan speed of the cooling device 396. As yet another example, in an embodiment in which the embedded controller 304 executing code instructions for the lexical similarity search module 391 determines that the hardware or firmware capability to verify authenticity of a BIOS update according to national institute of standards and technology (NIST) security recommendations, or to update a cryptographic algorithm or keys used therein for validating the hardware component as a trusted or secure hardware component during a secure boot up of the BIOS 310, the embedded controller 304 may instruct BIOS firmware 310 to execute these hardware or firmware capabilities. In such a way, the embedded controller 304 executing code instructions of the firmware-level AI productivity tool 380 in an embodiment may match the received user query inputs to known hardware or firmware capabilities of one or more hardware components (e.g., 308, 310, 383, 390, or 396) through execution by the embedded controller 304 of machine readable code instructions for the firmware-level AI productivity tool 380.

The method may then proceed to 426. The hardware processor executing machine readable code instructions of the firmware adjustment listening module in an embodiment at block 426 may detect a hardware component settings adjustment resulting from execution of a best match hardware or firmware capability. In order to ensure that all potentially useful firmware or hardware component adjustments that may be used to augment any previously performed responsive application capability at the operating system level, the adjustments to firmware or hardware components conducted via the firmware-level AI productivity tool are recorded by the firmware adjustment listening module monitoring traffic and executions by the embedded controller. The adjustments to the firmware or hardware components conducted via the firmware-level AI productivity tool are reported to the operating system and input to a system state monitoring service at the operating system. This system state monitoring service may be accessed by the OTB AI productivity tool and other software applications for current settings of hardware as adjusted at the platform level by the embedded controller executing the firmware-level AI productivity tool. In some embodiments, the method may end.

At block 428, the OTB AI productivity tool executing at the operating system may determine if any additional application capabilities of an AI productivity tool-enableable software application and any additional firmware or hardware adjustments are still necessary. In an aspect, reporting of the adjustments to the firmware or hardware components conducted via the firmware-level AI productivity tool to the system state monitoring system may be fed in to the OTB AI productivity tool similar to a user query input to determine as described above, if additional AI productivity tool-enableable software application capabilities are needed. If additional application capabilities are recommended or required at block 428, the process may return to block 410 for the OTB AI productivity tool at the operating system level to operate as before in tandem with the firmware-level AI productivity tool to determine additional application capabilities as well as additional firmware or hardware adjustments. When no additional application capabilities are recommended or required at block 428, the process may end.

The blocks of the flow diagram of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer readable code instructions for a firmware-level artificial intelligence (AI) productivity tool comprising:
an embedded controller executing computer-readable code instructions for accessing natural language descriptions of hardware or firmware capabilities associated with each of a plurality of hardware components from a natural language hardware capabilities library in a memory device;
a hardware processor executing computer-readable code instructions for a firmware adjustment listening module to identify that recent execution of a best match responsive application capability by an AI productivity tool enableable software application at an operating system level in response to a received user query input and transmitting identification of the best match responsive application capability to the embedded controller executing computer-readable code instructions of the firmware-level AI productivity tool;
the embedded controller executing computer-readable program code instructions for performing a keyword matching between natural language of the user query input and the identification of the best match responsive application capability with each of the natural language descriptions for the gathered hardware or firmware capabilities to generate a lexical similarity search score for each of the natural language descriptions for the gathered hardware or firmware capabilities to identify a best match responsive hardware or firmware capability having a highest lexical similarity search score; and
the embedded controller executing computer-readable program code instructions for instructing firmware for one or more of the plurality of hardware components associated with the best match hardware or firmware capability to execute the best match hardware or firmware capability controlled at a platform level for the information handling system in response to the user query input to augment execution of the best match responsive application capability.

2. The information handling system of claim 1 further comprising:
the embedded controller executing computer-readable program code instructions of the firmware-level AI productivity tool to perform keyword matching using a text frequency-inverted document frequency (TF-IDF) comparison between the natural language of the user query input and the identification of the best match responsive application capability with each of the natural language descriptions for the gathered hardware or firmware capabilities stored in the natural language hardware capabilities library.

3. The information handling system of claim 1 further comprising:
the hardware processor executing computer-readable code instructions for an on the box AI productivity tool software module at the operating system level to receive a user query input via an input/output device and identify the best match responsive application capability of an AI productivity tool-enablable software application at the operating system via a semantic similarity matching algorithm.

4. The information handling system of claim 1 further comprising:
the hardware processor executing computer-readable code instructions for the firmware adjustment listening module to monitor activity by the embedded controller to determine adjustments to firmware or hardware by execution of the best match hardware or firmware capability controlled at a platform level for the information handling system and reporting the adjustments to firmware or hardware to the operating system.

5. The information handling system of claim 4 further comprising:
the hardware processor executing computer-readable code instructions for the firmware adjustment listening module to report the adjustments to firmware or hardware to the operating system; and
the hardware processor executing computer-readable code instructions for an on the box AI productivity tool software module at the operating system level to receive description of the adjustments to firmware or hardware at the platform level and determining, via semantic similarity matching, an additional application capability for execution based on the report of the adjustments to the firmware or hardware at the platform level and the user query input.

6. The information handling system of claim 1 further comprising:
the embedded controller executing computer-readable program code instructions of firmware for the hardware component to perform the best match hardware or firmware capability to place a battery in a preset power save mode to conserve power to augment the best match responsive application capability responsive to a user query input requesting to extend battery life of the information handling system.

7. The information handling system of claim 1 further comprising:
a hardware processor executing computer-readable program code instructions at the operating system level for generating a query input intent value for the user query input;
the hardware processor executing computer-readable program code instructions for performing a semantic similarity search comparing the query input intent value to a plurality of capability intent values generated from natural language descriptions of gathered capabilities associated with each of a plurality of AI productivity tool-enablable software applications; and
the hardware processor executing computer-readable program code instructions for identifying the best match application capability for the received user query input having a capability intent value that generates a highest semantic similarity search score.

8. A method of augmenting functionality of an artificial intelligence (AI) productivity tool-enableable software application in response to a received user query with recommended adjustments to hardware component settings comprising:
storing, via a natural language hardware capabilities library memory accessible to an embedded controller, natural language descriptions of hardware or firmware capabilities associated with each of a plurality of hardware components for an information handling system;
identifying, via a hardware processor executing computer-readable code instructions for a firmware adjustment listening module, a recent execution of a best match responsive application capability by an AI productivity tool enableable software application in response to a received user query input;
transmitting, via the hardware processor executing computer-readable program code instructions for the firmware adjustment listening module, the received user query input and identification of the best match responsive application capability to the firmware-level AI productivity tool executing at the embedded controller;
performing, via the embedded controller executing computer-readable program code instructions, a lexical keyword comparison between natural language of the user query input and the identification of the best match responsive application capability with each of the natural language descriptions for the hardware or firmware capabilities to generate a lexical similarity search score for each of the natural language descriptions for the gathered hardware or firmware capabilities and identifying the best match hardware or firmware capability for the received user query input and the identification of the best match responsive application capability having a highest lexical similarity search score; and
instructing, via the embedded controller, firmware for one or more of the plurality of hardware components associated with the best match hardware or firmware capability to execute the best match hardware or firmware capability in response to the user query input to augment the best match responsive application capability executing at an operating system level of the information handling system.

9. The method of claim 8 further comprising:
performing the best match hardware or firmware capability to place a battery in a preset power save mode to conserve power in response to a detected execution of a best match application capability for ceasing execution of background applications.

10. The method of claim 8 further comprising:
performing the best match hardware or firmware capability to turn off a keyboard backlight in response to a detected execution of a best match application capability for ceasing execution of background applications.

11. The method of claim 8 further comprising:
performing the best match hardware or firmware capability to adjust settings for a cooling device according to a user selectable thermal table (USTT) in response to a detected execution of a best match application capability for an AI productivity tool-enableable software application for securing the information handling system.

12. The method of claim 8 further comprising:
performing the best match hardware or firmware capability to verify authenticity of a basic input/output system (BIOS) update according to national institute of standards and technology (NIST) security recommendation in response to a detected execution of a best match application capability for an AI productivity tool-enableable software application for securing the information handling system.

13. The method of claim 8 further comprising:
performing the best match hardware or firmware capability, via a hardware root of trust (HRoT) system in firmware for the hardware component to update a cryptographic algorithm or keys used therein for validating the hardware component as a trusted or secure hardware component during a secure boot up of the basic input/output system (BIOS) in response to a detected execution of a best match application capability for an AI productivity tool-enableable software application for securing the information handling system.

14. The method of claim 8 further comprising:
performing the best match hardware or firmware capability to perform diagnostics on the hardware component in response to a detected execution of a best match application capability for an AI productivity tool-enableable software application to perform operating system diagnostics.

15. An information handling system executing computer readable code instructions for an on the box (OTB) artificial intelligence (AI) productivity tool in tandem with a firmware-level AI productivity tool comprising:
a hardware processor executing machine readable code instructions at an operating system level of the OTB AI productivity tool to identify and execute a responsive application capability in response to a user query input received via an input/output device;
the hardware processor executing machine readable code instructions of the firmware adjustment listening module to detect execution of the responsive application capability at an operating system level and to transmit a responsive application capability natural language description of the responsive application capability to an embedded controller executing the firmware-level AI productivity tool;
the embedded controller executing computer-readable program code instructions for performing a keyword matching between the responsive application capability natural language description with natural language descriptions for gathered hardware or firmware capabilities stored in a natural language hardware capability library accessible to the embedded controller to generate a lexical similarity search score for each of the gathered hardware or firmware capabilities to identify a best match hardware or firmware capability having a highest lexical similarity search score to augment execution of the responsive application capability; and
the embedded controller executing computer-readable program code instructions for instructing firmware for one or more of the plurality of hardware components associated with the best match hardware or firmware capability to execute the best match hardware or firmware capability controlled at a platform level for the information handling system.

16. The information handling system of claim 15 further comprising:
the embedded controller executing computer-readable program code instructions of the firmware-level AI productivity tool to perform the keyword matching using a text frequency-inverted document frequency (TF-IDF) comparison between a user query input and the identification of the best match responsive application capability with each of the natural language descriptions for the gathered hardware or firmware capabilities stored in the natural language hardware capabilities library.

17. The information handling system of claim 15 further comprising:
the hardware processor executing computer-readable code instructions for the OTB AI productivity tool software module at the operating system level to receive the user query input and identify the responsive application capability of an AI productivity tool-enablable software application executing at the operating system via a semantic similarity matching algorithm to match the user query input to the responsive application capability of the AI productivity tool-enablable software application.

18. The information handling system of claim 15 further comprising:
the hardware processor executing computer-readable code instructions for the firmware adjustment listening module to monitor activity by the embedded controller to determine adjustments to firmware or hardware by execution of the best match hardware or firmware capability controlled at a platform level for the information handling system and reporting the adjustments to the firmware or hardware to the operating system.

19. The information handling system of claim 15 further comprising:
the hardware processor executing computer-readable code instructions for the firmware adjustment listening module to report adjustments to firmware or hardware at the platform level by execution of the best match hardware or firmware capability to the operating system; and
the hardware processor executing computer-readable code instructions for the OTB AI productivity tool software module at the operating system level to receive description of the adjustments to the firmware or hardware and determining, via semantic similarity matching, an additional application capability for execution or an additional firmware or hardware adjustment based on the report of the adjustments to firmware or hardware at the platform level.

20. The information handling system of claim 15 further comprising:
the embedded controller executing computer-readable program code instructions of firmware for the hardware component to perform the best match hardware or firmware capability to adjust settings for a cooling device according to a user selectable thermal table (USTT) to augment the best match responsive application capability to increase performance of the information handling system.
